(19) United States
(12) Patent Application Publication
(10) Pub. No.: US 2024/0203096 A1
(43) Pub. Date: Jun. 20, 2024

(54) DEVICES AND METHODS FOR DETECTING FOREIGN MATTERS AND MANAGING RESIDUES IN CATHODE ACTIVE MATERIALS BASED ON SPECTRAL IMAGES

(71) Applicant: SK Planet Co., Ltd., Seongnam-si (KR)

(72) Inventor: Yeonghyeon PARK, Cheonan-si (KR)

(21) Appl. No.: 18/543,271

(22) Filed: Dec. 18, 2023

(30) Foreign Application Priority Data
Dec. 19, 2022 (KR) 10-2022-0178757
Dec. 19, 2022 (KR) 10-2022-0178758

(51) Int. Cl. G06V 10/764; G01N 21/31; G06T 7/00; G06T 7/11; G06T 7/194; G06V 10/143; G06V 10/762; G06V 10/94; H04N 7/18; H04N 23/60

(52) U.S. Cl. CPC G06V 10/764; G01N 21/31; G06T 7/001; G06T 7/11; G06T 7/194; G06V 10/143; G06V 10/762; G06V 10/95; H04N 7/183; H04N 23/64; G06T 2207/30108

(57) ABSTRACT

A device and method are provided for detecting foreign matters in a cathode active material by identifying, based on a spectral image of the cathode active material, whether the cathode active material contains foreign matters. In addition, a device and method are provided for managing residues in a cathode active material by controlling the residual amount of a removal target in the cathode active material, based on a spectral image of the cathode active material.

### CROSS-REFERENCE TO RELATED APPLICATIONS

The present application priority to Republic of Korea Patent Application No. 10-2022-0178757, filed on Dec. 19, 2022, and Republic of Korea Patent Application No. 10-2022-0178758, filed on Dec. 19, 2022, which are incorporated by reference herein in their entirety.

### TECHNICAL FIELD

The present disclosure relates generally to cathode active material management technologies using spectral images. Specifically, the present disclosure relates to a technology for detecting foreign matters in a cathode active material using a spectral image and a technology for efficiently managing the amount of residue in the cathode active material using a spectral image.

### BACKGROUND ART

As the demand for and development of portable electronic devices or electric vehicles increase, the demand for secondary batteries used as an energy source is also rapidly increasing. Accordingly, much research is being conducted on secondary batteries that can be used in various electronic devices, and especially, research is focused on lithium secondary batteries with high energy density, high discharge voltage, and output stability.

Lithium secondary batteries used in electric vehicles, etc., are required to have the characteristics of high energy density and large output in a short period of time, as well as to be able to be used for more than 10 years even under harsh conditions where charging and discharging by large currents is repeated in a short period of time. This lithium secondary battery has a structure that includes a positive electrode (i.e., cathode), a negative electrode (i.e., anode), an electrolyte, and a separator. A currently commercialized typical lithium secondary battery uses carbon such as graphite as an anode active material and uses oxide containing lithium as a cathode active material. The electrolyte is a material that acts as a medium for ion movement to enable redox reactions to occur at electrodes. In a lithium ion battery (LIB), an organic solution containing lithium salt is used as electrolyte. In a lithium ion polymer battery (LIPB), a gel-type electrolyte solution is used. The separator is intended to prevent physical contact between the cathode and the anode and has a microprocess structure for the movement of ions, and polyolefin porous membrane or polyvinylidene fluoride (PVDF) is mainly used.

Meanwhile, as the cathode active material in the lithium ion battery, lithium transition metal oxide containing lithium is mainly used, and layered lithium transition metal oxides such as cobalt-based, nickel-based, and ternary-based oxides in which cobalt, nickel, and manganese coexist are used in more than 90% of cases. The cathode active material goes through a powder form during a manufacturing process, and if foreign matters are included during this process, the electrochemical properties of the cathode active material may be significantly deteriorated. Thus, management of foreign matters during the manufacturing process of the cathode active material is required.

In addition, during the manufacturing process of the cathode active material, residual lithium ions such as LIOH, LI₂CO₃, etc. that did not participate in the manufacturing reaction of the cathode active material may be contained in the cathode active material. Since such residual lithium ions cause a decrease in the electrochemical properties of the cathode active material, it is necessary to manage the residual lithium ions generated during the manufacturing process of the cathode active material.

### SUMMARY

Accordingly, the present disclosure is intended to provide a device and method for detecting foreign matters in a cathode active material by identifying, based on a spectral image of the cathode active material, whether the cathode active material contains foreign matters. This supports the manufacture of a more reliable cathode active material.

In addition, the present disclosure is intended to provide a device and method for managing residues in a cathode active material by controlling the residual amount of a removal target in the cathode active material, based on a spectral image of the cathode active material. This supports a more efficient manufacturing process for the cathode active material.

According to an embodiment of the present disclosure, a spectral image-based foreign matter detection device may include a spectroscopic camera that acquires a spectral image of a cathode active material, and a processor functionally connected to the spectroscopic camera. The processor may be configured to control the spectroscopic camera to acquire a current spectral image of the cathode active material, to separate a foreground area where the cathode active material is distributed, and a background area other than the foreground area in the current spectral image, to divide the separated foreground area into a predefined number of segment regions, to compare each of the segment regions with a pre-stored reference model to determine whether a foreign matter is contained, and to output information about the segment region containing the foreign matter.

In the foreign matter detection device, the processor may be configured to distinguish between a segment region containing the foreign matter and a segment region not containing the foreign matter, and to output distinguished information to a display.

In the foreign matter detection device, the processor may be configured to separately classify the cathode active material of the segment region containing the foreign matter and the cathode active material of the segment region not containing the foreign matter.

In the foreign matter detection device, the processor may be configured to separate the foreground area and the background area through unsupervised learning-based clustering by applying a nearest neighbor technique or an autoencoder to the current spectral image.

In the foreign matter detection device, the processor may control a vibration of an active material support on which the cathode active material is placed, so that the cathode active material is distributed to a uniform thickness.

In the foreign matter detection device, the processor may be configured to transmit information about the segment region containing the foreign matter to a user terminal.

According to an embodiment of the present disclosure, a spectral image-based foreign matter detection method, performed by a processor of a foreign matter detection device, may include controlling a spectroscopic camera to acquire a current spectral image of a cathode active material; separating a foreground area where the cathode active material is distributed, and a background area other than the foreground area in the current spectral image; dividing the separated foreground area into a predefined number of segment regions; comparing each of the segment regions with a pre-stored reference model to determine whether a foreign matter is contained; and outputting information about the segment region containing the foreign matter.

In the foreign matter detection method, the outputting may include at least one of distinguishing between a segment region containing the foreign matter and a segment region not containing the foreign matter, and outputting distinguished information to a display; and transmitting information about the segment region containing the foreign matter to a user terminal.

The foreign matter detection method may further include separately classifying the cathode active material of the segment region containing the foreign matter and the cathode active material of the segment region not containing the foreign matter.

In the foreign matter detection method, the separating may include separating the foreground area and the background area through unsupervised learning-based clustering by applying a nearest neighbor technique or an autoencoder to the current spectral image.

According to an embodiment of the present disclosure, a server device supporting a spectral image-based foreign matter detection may include a server communication circuit establishing a communication channel with a foreign matter detection device, and a server processor functionally connected to the server communication circuit. The server processor may be configured to acquire a current spectral image of a cathode active material from the foreign matter detection device, to separate a foreground area where the cathode active material is distributed, and a background area other than the foreground area in the current spectral image, to divide the separated foreground area into a predefined number of segment regions, to compare each of the segment regions with a pre-stored reference model to determine whether a foreign matter is contained, and to transmit information about the segment region containing the foreign matter to the foreign matter detection device.

In the server device, the server processor may be configured to distinguish between a segment region containing the foreign matter and a segment region not containing the foreign matter, and to transmit distinguished information to the foreign matter detection device.

According to an embodiment of the present disclosure, a spectral image-based residue control device may include a spectroscopic camera that acquires a spectral image of a cathode active material, and a processor functionally connected to the spectroscopic camera. The processor may be configured to acquire a current spectral image of the cathode active material disposed in a chamber and containing a removal target during a heat treatment process for removing the removal target from the cathode active material, to identify a residual amount of the removal target by comparing a spectrum corresponding to the current spectral image with a pre-stored reference model, and to control an operation of the chamber differently depending on the residual amount of the removal target.

In the residue control device, the removal target may include residual lithium ions contained in the cathode active material.

In the residue control device, the processor may be configured to create first control information for performing a next process during the heat treatment process when the residual amount of the removal target is less than a predefined reference value, and to transmit the first control information to the chamber. The first control information may include at least one of a cooling temperature and a cooling rate related to a cooling process of the chamber.

In the residue control device, the processor may be configured to create second control information for repeating the heat treatment process when the residual amount of the removal target is greater than or equal to a predefined reference value, and to transmit the second control information to the chamber. The second control information may include at least one of a temperature value and a heating maintenance time related to maintaining a heating state in the chamber, and/or at least one of a temperature rise rate, a temperature rise value, and a heating maintenance time in the chamber.

In the residue control device, the processor may be configured to output, on a display, information about at least one of a temperature rise rate, a heating temperature, a cooling rate, and a work termination in the chamber, which vary depending on the residual amount of the removal target.

According to an embodiment of the present disclosure, a spectral image-based residue control method, performed by a processor of a residue control device, may include acquiring a current spectral image of a cathode active material disposed in a chamber and containing a removal target during a heat treatment process for removing the removal target from the cathode active material; identifying a residual amount of the removal target by comparing a spectrum corresponding to the current spectral image with a pre-stored reference model; and controlling an operation of the chamber differently depending on the residual amount of the removal target.

In the residue control method, the controlling may include creating first control information for performing a next process during the heat treatment process when the residual amount of the removal target is less than a predefined reference value, and transmitting the first control information to the chamber.

In the residue control method, the controlling may include creating second control information for repeating the heat treatment process when the residual amount of the removal target is greater than or equal to a predefined reference value, and transmitting the second control information to the chamber.

According to an embodiment of the present disclosure, a server device supporting a spectral image-based residue control may include a server communication circuit establishing a communication channel with a residue control device, and a server processor functionally connected to the server communication circuit. The server processor may be configured to receive, from the residue control device, a current spectral image of a cathode active material disposed in a chamber and containing a removal target during a heat treatment process for removing the removal target from the cathode active material, to identify a residual amount of the removal target by comparing a spectrum corresponding to the current spectral image with a pre-stored reference model, and to control an operation of the chamber differently depending on the residual amount of the removal target.

In the server device, the server processor may be configured to create first control information for performing a next process during the heat treatment process when the residual amount of the removal target is less than a predefined reference value, and transmit the first control information to the chamber, or to create second control information for repeating the heat treatment process when the residual amount of the removal target is greater than or equal to a predefined reference value, and transmit the second control information to the chamber.

According to the present disclosure, the foreign matter detection device and method can provide a more accurate foreign matter detection function while reducing the amount of calculation required to detect foreign matters.

In addition, according to the present disclosure, the residue management device and method can efficiently manage the residual amount of the removal target in the cathode active material manufacturing process, improve the manufacturing process time, reliably manage the removal target residual amount below the reference value, and obtain high quality results.

### DESCRIPTION OF DRAWINGS

FIG. 1 is a diagram illustrating an example of a system environment supporting a foreign matter detection in a process of manufacturing a cathode active material according to a first embodiment of the present disclosure.

FIG. 2 is a block diagram illustrating an exemplary configuration of a foreign matter detection device according to the first embodiment of the present disclosure.

FIG. 3 is a block diagram illustrating an exemplary configuration of the processor shown in FIG. 2.

FIG. 4 is a block diagram illustrating an exemplary configuration of a server device according to the first embodiment of the present disclosure.

FIG. 5 is a flowchart illustrating an example of a method for detecting foreign matters in a cathode active material based on a spectral image according to the first embodiment of the present disclosure.

FIG. 6 is a flowchart illustrating another example of a method for detecting foreign matters in a cathode active material based on a spectral image according to the first embodiment of the present disclosure.

FIG. 7 is a diagram illustrating an example of a system environment supporting a residue management in a process of manufacturing a cathode active material according to a second embodiment of the present disclosure.

FIG. 8 is a block diagram illustrating an exemplary configuration of a residue management device according to the second embodiment of the present disclosure.

FIG. 9 is a block diagram illustrating an exemplary configuration of the processor shown in FIG. 8.

FIG. 10 is a block diagram illustrating an exemplary configuration of a server device according to the second embodiment of the present disclosure.

FIG. 11 is a flowchart illustrating an example of a method for managing residues in a cathode active material based on a spectral image according to the second embodiment of the present disclosure.

### DETAILED DESCRIPTION

Now, embodiments of the present disclosure will be described in detail with reference to the accompanying drawings.

However, in the following description and the accompanying drawings, well known techniques may not be described or illustrated in detail to avoid obscuring the subject matter of the present disclosure. Through the drawings, the same or similar reference numerals denote corresponding features consistently.

The terms and words used in the following description, drawings and claims are not limited to the bibliographical meanings thereof and are merely used by the inventor to enable a clear and consistent understanding of the disclosure. Thus, it will be apparent to those skilled in the art that the following description about various embodiments of the present disclosure is provided for illustration purpose only and not for the purpose of limiting the disclosure as defined by the appended claims and their equivalents.

Additionally, the terms including expressions “first”, “second”, etc. are used for merely distinguishing one element from other elements and do not limit the corresponding elements. Also, these ordinal expressions do not intend the sequence and/or importance of the elements.

Further, when it is stated that a certain element is “coupled to” or “connected to” another element, the element may be logically or physically coupled or connected to another element. That is, the element may be directly coupled or connected to another element, or a new element may exist between both elements.

In addition, the terms used herein are only examples for describing a specific embodiment and do not limit various embodiments of the present disclosure. Also, the terms “comprise”, “include”, “have”, and derivatives thereof mean inclusion without limitation. That is, these terms are intended to specify the presence of features, numerals, steps, operations, elements, components, or combinations thereof, which are disclosed herein, and should not be construed to preclude the presence or addition of other features, numerals, steps, operations, elements, components, or combinations thereof.

In addition, the terms such as “unit” and “module” used herein refer to a unit that processes at least one function or operation and may be implemented with hardware, software, or a combination of hardware and software.

In addition, the terms “a”, “an”, “one”, “the”, and similar terms are used herein in the context of describing the present invention (especially in the context of the following claims) may be used as both singular and plural meanings unless the context clearly indicates otherwise

Also, embodiments within the scope of the present invention include computer-readable media having computer-executable instructions or data structures stored on computer-readable media. Such computer-readable media can be any available media that is accessible by a general purpose or special purpose computer system. By way of example, such computer-readable media may include, but not limited to, RAM, ROM, EPROM, CD-ROM or other optical disk storage, magnetic disk storage or other magnetic storage devices, or any other physical storage medium that can be used to store or deliver certain program codes formed of computer-executable instructions, computer-readable instructions or data structures and which can be accessed by a general purpose or special purpose computer system.

### First Embodiment

Hereinafter, a system environment that supports detection of foreign matters, generated during a process of manufacturing a cathode active material, by using a spectral image segmentation method based on self-supervised learning will be described. In addition, the types and roles of components included in the system will also be described.

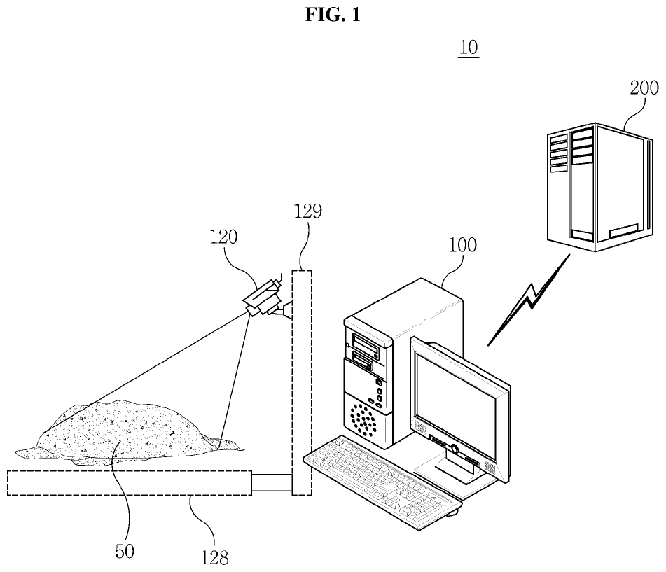

FIG. 1 is a diagram illustrating an example of a system environment 10 supporting a foreign matter detection in a process of manufacturing a cathode active material according to a first embodiment of the present disclosure.

Referring to FIG. 1, the system environment 10 may include a cathode active material 50, a foreign matter detection device 100 capable of photographing at least a partial region of the cathode active material 50, and a server device 200 capable of supporting the foreign matter detection device 100. In the system environment 10 shown in FIG. 1, the foreign matter detection device 100 and the server device 200 establish a communication channel, and the server device 200 supports the foreign matter detection device 100. However, this is exemplary only, and the present disclosure is not limited to this example. In another example, the system environment 10 may be configured to perform spectral image collection and foreign matter detection from the cathode active material 50, based on a single electronic device (e.g., the foreign matter detection device 100) capable of executing an embedded program, instead of a combination of the foreign matter detection device 100 and the server device 200. That is, in a certain case, the server device 200 may be omitted from the system environment 10.

The cathode active material 50 is a major material constituting a cathode material and may be in powder form during a manufacturing process. For example, the cathode active material 50 may be manufactured as follows. Metal solutions are prepared by dissolving Ni, Co, and Mn in a strong acid solution such as sulfuric acid, and the prepared metal solutions are mixed to prepare a mixed metal solution. Then, a complexing agent is mixed to the mixed metal solution, and a pH adjuster such as NaOH is added to form and precipitate hydroxide. The precipitated hydroxide is washed and dried to prepare a precursor, and the precursor is produced into a metal oxide through a high temperature reaction. The metal oxide is mixed with a lithium-based material such as LiOH and fired in an oxidizing atmosphere to produce cathode active material powder. Thereafter, a conductive agent, a binder, etc. may be added to the cathode active material 50 to produce a cathode material.

As described above, in the process of manufacturing the cathode active material 50, the cathode active material 50 may be in a powder form. If fine foreign matters enter the powder during this process, the electrochemical properties of the cathode material may rapidly deteriorate. In the present disclosure, it is possible to check whether foreign matters have been added to the cathode active material 50 by using a spectroscopic camera 120. Also, it is possible to produce a more reliable cathode material by taking necessary measures based on the check results.

The foreign matter detection device 100 may acquire a spectral image of the cathode active material 50. For example, the foreign matter detection device 100 may be configured to approach the cathode active material 50 within a certain distance and capture the cathode active material 50 as a spectral image with a resolution of a certain value or more. In addition, the foreign matter detection device 100 may include a structure capable of uniformly distributing the cathode active material 50 within a certain area so as to obtain a uniform spectral image of the cathode material 50 in powder form. Specifically, the foreign matter detection device 100 may include a spectroscopic camera 120, a camera holder 129, and an active material support 128. The camera holder 129 holds the spectroscopic camera 120 and allows linear and/or rotational movements of the spectroscopic camera 120. The active material support 128 controls the arrangement of the cathode active material 50. The active material support 128 is provided so that the cathode active material 50 in powder form can be distributed at a certain thickness. The active material support 128 may be provided as a separate component rather than being included in the foreign matter detection device 100.

The spectroscopic camera 120 can capture a spectral image of the cathode active material 50 located within a certain angle and a certain distance. The camera holder 129 is configured to at least temporarily hold the spectroscopic camera 120, and enables at least one of linear movement and rotational movement at a specific angle of the spectroscopic camera 120 in at least one of the forward and backward, left and right, and up and down directions. Accordingly, the foreign matter detection device 100 can adjust a photographing range for the cathode active material 50 as needed. For example, the foreign matter detection device 100 can adjust at least one of a photographing distance and a photographing angle between the spectroscopic camera 120 and the active material support 128 depending on the shape (e.g., area) of the cathode active material 50 distributed on the active material support 128, thereby photographing all predefined areas of the cathode active material 50 placed on the active material support 128.

The active material support 128 may include a vibrating conveyor belt that can vibrate in a specific direction according to a predefined frequency so that the cathode active material 50 placed in powder form on the upper surface can be evenly spread. The active material support 128 may include a support substrate on which the cathode active material 50 is placed, and at least one vibration module capable of vibrating in at least an up and down direction under the control of the foreign matter detection device 100. In this case, since the thickness of the cathode active material 50 accumulated on the support substrate may vary depending on the region, the active material support 128 may further include a structure capable of tilting the support substrate in at least one direction. The active material support 128 may vibrate up and down under the control of the foreign matter detection device 100 while at least a portion of the support substrate is raised higher than the ground compared to other portions. In this regard, the foreign matter detection device 100 may analyze the captured image of the cathode active material 50 placed on the active material support 128 using the spectroscopic camera 120, and identify the thickness of each region of the cathode active material 50 based on the analysis results. Then, the foreign matter detection device 100 may control the support substrate to vibrate according to a predefined frequency in a state where the support substrate is tilted so that the portion of the support substrate on which the cathode active material 50 is relatively thickly accumulated is at a higher position from the ground than other portions. Additionally, the foreign matter detection device 100 may adjust the dispersion speed of the cathode active material 50 by adjusting the frequency depending on the distribution form of the cathode active material 50. Additionally, the foreign matter detection device 100 may adjust the vibration magnitude to precisely control the thickness of the cathode active material 50 accumulated in a specific area of the support substrate. Until the total thickness of the cathode active material 50 becomes less than a specified thickness (e.g., a thickness sufficient to transmit light for spectral image capturing), the foreign matter detection device 100 may control the operation of the active material support 128. The foreign matter detection device 100 may separate the foreground (e.g., the area where the cathode active material is distributed) and the background (e.g., the area other than the foreground) in the spectral image so as to detect foreign matter in the obtained spectral image of the cathode active material 50. Then, the foreign matter detection device 100 may compare the separated data with a pre-stored reference model and perform foreign matter detection based on the comparison result for each segment region. Also, the foreign matter detection device 100 may identify a specific area with foreign matter in a plurality of segment regions and separate the cathode active material in the identified area with foreign matter and the other area without foreign matter by using a cutter that can separate such areas.

The foreign matter detection device 100 may support a model creation operation based on self-supervised learning in relation to reference model creation. In this process, the foreign matter detection device 100 may collect various spectral images of a cathode active material, separate the foreground and the background, perform classification model learning on the separated data, and provide the learning results to the user. The user may record the category of the result (e.g., with foreign matter, without foreign matter, or type of foreign matter), and perform the creation of a reference model corresponding to the spectral images of the cathode active material containing foreign matter. Additionally, the foreign matter detection device 100 may acquire an RGB image for the cathode active material, and provide the acquired RGB image to the user along with a spectral image of the cathode active material to be used as a material for determining whether the cathode active material under inspection contains foreign matter.

Additionally, the foreign matter detection device 100 may obtain a foreign matter detection result for the cathode active material 50 through the server device 200. In this case, the foreign matter detection device 100 may not perform the foreground and background separation and the model comparison analysis based on separated data on the acquired spectral image. In this case, the foreign matter detection device 100 may only transmit the acquired spectral image to the server device 200 and then receive the foreign matter detection result from the server device 200. In addition, when the foreign matter detection device 100 is configured to independently perform foreign matter detection, classification, and result output without the server device 200, the foreign matter detection device 100 may receive the reference model in advance from the external server device and store and use it. The reference model may be a model generated by performing machine learning (or self-supervised learning, or unsupervised learning) on various spectral images of a cathode active material. The reference model can be created based on a variety of spectral images. Also, using various spectral images of a cathode active material in which the foreground and the background are separated, the reference model may be generated based on a predetermined background and a plurality of foregrounds.

The server device 200 may establish a communication channel with the foreign matter detection device 100. The server device 200 may receive at least one spectral image of the cathode active material 50 from the foreign matter detection device 100 and perform foreign matter detection on the at least one received spectral image. In this process, the server device 200 may pre-store a reference model for comparative analysis of the currently acquired spectral image. The reference model may be created by separating the foreground and the background in the spectral images collected and provided by the foreign matter detection device 100, providing the separated foreground data (or spectrum) to the user as N samples per class, and determining the type of class of the corresponding foreground data based on a user input. Alternatively, the reference model may be received from a designated external server device. When the server device 200 performs a function of providing a result of whether a spectral image of the current cathode active material contains foreign matter, it may derive a comparative analysis result between the current spectral image and the reference model, and provide the derived result to the foreign matter detection device 100. Meanwhile, when the resolution of the acquired spectral image is low or a higher resolution spectral image is needed, the server device 200 may request the foreign matter detection device 100 to adjust the resolution of the spectral image for the cathode active material 50, and obtain the spectral image with improved resolution. In this case, the foreign matter detection device 100 may adjust the photographing angle and photographing distance of the spectroscopic camera 120, take a new spectral image of the cathode active material 50, and provide it to the server device 200.

As described above, in the system environment 10 that supports the foreign matter detection function according to the first embodiment of the present disclosure, the foreign matter detection device 100 acquires a spectral image of the cathode active material 50, separates the foreground and background in the acquired spectral image, creates a reference model by clustering the separated data and determining the type based on a user input, and compare the reference model with the currently acquired spectral image of the cathode active material 50 to determine whether foreign matter is contained.

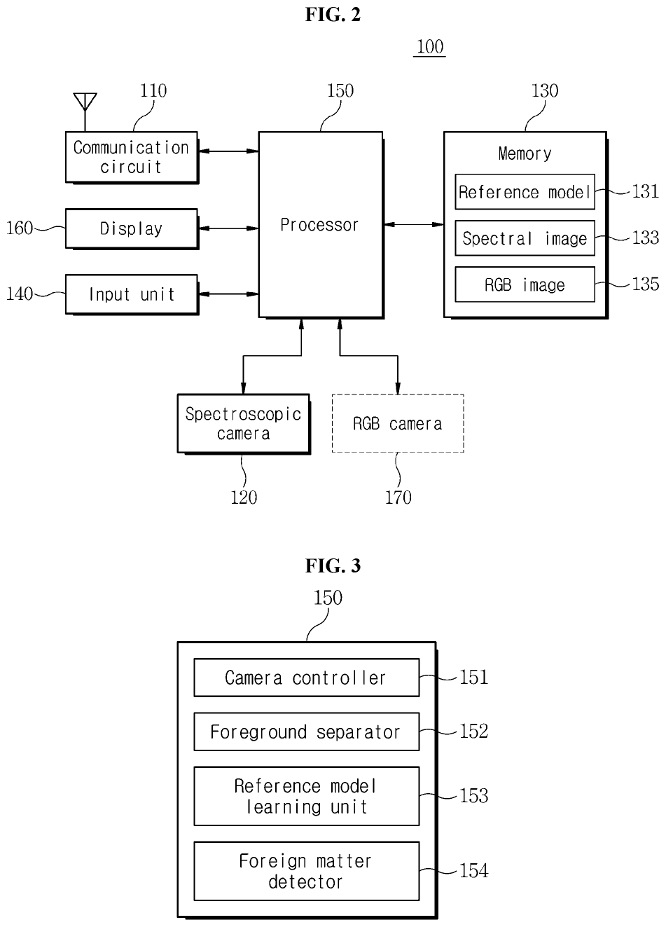

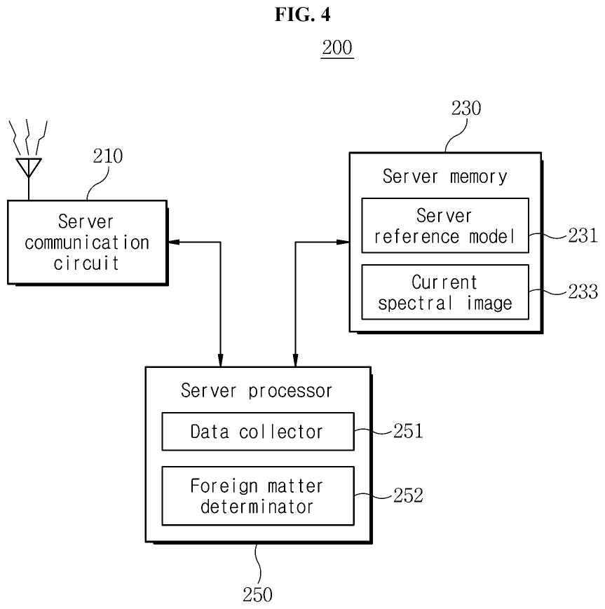

FIG. 2 is a block diagram illustrating an exemplary configuration of a foreign matter detection device according to the first embodiment of the present disclosure, and FIG. 3 is a block diagram illustrating an exemplary configuration of the processor shown in FIG. 2.

First, referring to FIG. 2, the foreign matter detection device 100 according to the first embodiment may include a communication circuit 110, a spectroscopic camera 120, a memory 130, an input unit 140, a display 160, and a processor 150. In addition, as previously described in FIG. 1, the foreign matter detection device 100 may further include at least one of the camera holder 129 and the active material support 128. The camera holder 129 can hold the spectroscopic camera 120 to photograph a spectral image of the cathode active material 50. The active material support 128 can adjust the applied thickness of the cathode active material 50. In addition, the foreign matter detection device 100 may further include a power source (e.g., permanent power source or battery) required for the operation of at least one of the above-mentioned components such as the communication circuit 110, the spectroscopic camera 120, the memory 130, the input unit 140, the display 160, and the processor 150. In addition, the foreign matter detection device 100 may further include an RGB camera 170 arranged to have a photographing angle and photographing distance that are the same or similar to those of the spectroscopic camera 120 for the cathode active material 50.

The communication circuit 110 may support the communication function of the foreign matter detection device 100. In an example, if the server device 200 is designed to perform the calculation required for detecting foreign matters from the cathode active material 50, the communication circuit 110 may send at least one spectral image collected by the spectroscopic camera 120 to the server device 200. In addition, depending on settings or under the control of the processor 150, the communication circuit 110 may send to the server device 200 an RGB image taken by the RGB camera 170 at the same viewpoint and target (e.g., cathode active material) as those of the spectroscopic camera 120.

Meanwhile, the foreign matter detection function can be independently performed by the foreign matter detection device 100. In this case, the communication circuit 110 may, under the control of the processor 150, transmit a message containing the inspection result by the foreign matter detection function to an administrator terminal or designated user terminal of the foreign matter detection device 100. Alternatively, the communication circuit 110 may output (or transmit) the message to the server device 200 under the control of the processor 150. If the foreign matter detection device 100 includes a separate output device (e.g., the display 160 or audio device), the message may be outputted through the output device. The communication circuit 110 may establish a communication channel with an external server device and receive a reference model 131 from the external server device. The reference model 131 may be a model generated, based on machine learning (or self-supervised learning, or unsupervised learning) on data in which foreground (e.g., the area where the cathode active material is distributed) and background (e.g., the area where the cathode active material is not distributed) of various spectral images related to the cathode active material 50 are separated, and based on type decisions made by the user. In this regard, the communication circuit 110 may establish a communication channel with an external server device at regular intervals under the control of the processor 150, and when there is a newly updated reference model 131, may receive the updated reference model 131 from the external server and store (or update) it in the memory 130.

The spectroscopic camera 120 is the spectroscopic camera 120 of the foreign matter detection device 100 previously described in FIG. 1 and may be arranged to capture a spectral image of the cathode active material 50. Although FIG. 1 shows that the foreign matter detection device 100 includes one spectroscopic camera 120, the present disclosure is not limited thereto. One or more spectral cameras 120 may be disposed. When a plurality of spectroscopic cameras are arranged, the plurality of spectroscopic cameras may be arranged to photograph the cathode active material 50 separately by region or to photograph the cathode active material 50 from various angles. The spectroscopic camera 120 may be activated under the control of the processor 150, and when a spectral image of the cathode active material 50 is acquired, it can be transmitted to the processor 150. Alternatively, under the control of the processor 150, the spectral image acquired by the spectroscopic camera 120 may be transmitted to the server device 200 through the communication circuit 110.

The memory 130 may store at least one program or data necessary for operating the foreign matter detection device 100. In an example, the memory 130 may temporarily or semi-permanently store a control program necessary for driving at least one spectroscopic camera 120, and a spectral image 133 acquired through the at least one spectroscopic camera 120. For example, the memory 130 may store the reference model 131 used for comparative analysis with a currently captured spectral image of the cathode active material 50. As mentioned above, the reference model 131 may be received from an external server device. If a plurality of spectral images 133 are accumulated and stored more than a predefined certain amount, the reference model 131 may be generated through the calculation of the processor 150 and a user input. When the foreign matter detection device 100 includes the RGB camera 170, the memory 130 may store an RGB image 135 related to the cathode active material 50 captured by the RGB camera 170. The RGB image 135 may be matched with the spectral image 133 captured by the spectroscopic camera 120 and stored in the memory 130. In the process of generating the reference model 131 based on the spectral image 133, the RGB image 135 may be provided to the user (e.g., outputted on the display 160 for user confirmation, or transmitted to a user's terminal). In an example, the reference model 131 may be generated, based on machine learning (or self-supervised learning, or unsupervised learning) on data in which foreground and background of the spectral images 133 are separated, and based on type decisions made by the user.

The input unit 140 may include various input tools for manipulating the foreign matter detection device 100. For example, the input unit 140 may create, in response to a user's manipulation, at least one of an input signal for activating the spectroscopic camera 120, an input signal for manipulating the spectroscopic camera 120 to acquire the spectral image 133, an input signal for manipulating the RGB camera 170, and an input signal for requesting the analysis result of the spectral image 133. The input unit 140 may include at least one of a soft key (or a touch-sensitive input mechanism in a touch screen or a touch pad), a physical key, a voice input device, a gesture input device, a jog shuttle, and the like. The input unit 140 may generate a user's input regarding the type of spectral image 133 in response to a user's manipulation.

The display 160 may output at least one screen necessary for operating the foreign matter detection device 100. For example, the display 160 may output at least one of the following screens: a screen that indicates whether at least one component (e.g., the spectroscopic camera 120, the camera holder 129, the cathode material support 128, the communication circuit 110, the input unit 140, the RGB camera 170) included in the foreign matter detection device 100 is in a normal state, a screen for activating at least one of the spectroscopic camera 120 and the RGB camera 170, a screen for showing the spectral image 133 acquired through the spectroscopic camera 120, a screen for showing a foreign matter detection result according to the analysis of the spectral image 133, a screen for showing the RGB image 135 acquired through the RGB camera 170, a screen for entering the type of a foreign matter based on at least one of the analysis result of the spectral image and the RGB image 135. In addition, when the foreign matter detection device 100 is operated in conjunction with the server device 200, the display 160 may output at least one of a screen for connecting with the server device 200, and a screen for showing a foreign matter detection result of the spectral image 133 received from the server device 200.

The processor 150 may perform at least one of transmitting and processing signals necessary for operating the foreign matter detection device 100, storing processing results, and outputting the processing results. For example, the processor 150 may perform a process of generating the reference model 131 based on at least one of a spectral image collected by the spectroscopic camera 120 or a spectral image received from an external server device. In addition, the processor 150 may acquire the spectral image 133 by controlling the spectroscopic camera 120, separate the foreground and background from the acquired spectral image 133, perform comparative analysis between the separated data and the reference model 131 stored in the memory 130, and output the foreign matter detection results according to the comparative analysis. In this regard, the processor 150 may include a configuration as shown in FIG. 3.

Referring to FIG. 3, the processor 150 may include at least one of a camera controller 151, a foreground separator 152, a reference model learning unit 153, and a foreign matter detector 154.

The camera controller 151 controls at least a portion of the spectroscopic camera 120 or the camera holder 129 to enable the spectroscopic camera 120 to photograph the cathode active material 50 at a certain resolution or higher. In this regard, the camera holder 129 may perform at least one of linear movement and rotational movement at a specific angle in at least one of forward and backward, left and right, and up and down directions with respect to the cathode active material 50 in response to the operation of the camera controller 151. In the process of acquiring a spectral image of the cathode active material 50 placed on the active material support 128, the camera controller 151 may check whether the cathode active material 50 is evenly distributed. As a result of check, if the thickness of the accumulated cathode active material 50 is partially different, the camera controller 151 may control the active material support 128 such that the cathode active material 50 is evenly distributed. In the reference model creation operation, the camera controller 151 may control the spectroscopic camera 120 to acquire various spectral images of the cathode active material 50. In addition, the camera controller 151 may control the acquisition of RGB images 135 for the same viewpoint and the same target. If the size of the cathode active material 50 satisfies the condition that it is larger than a predefined size (or the condition that the resolution is larger than a certain resolution), the camera controller 151 may control to acquire a spectral image for the cathode active material 50.

The foreground separator 152 may separate the foreground and background of the spectral images collected by the camera controller 151. For example, the foreground separator 152 may separate the regions corresponding to the background and foreground in the spectral image of the cathode active material 50 into spectral units using an unsupervised method. In an example, the foreground separator 152 may perform unsupervised learning-based clustering by utilizing KNN (k-nearest neighbor) or through an autoencoder which is an example of an artificial neural network. When using the KNN, the number of clusters may be determined by the user or by an automatic assignment method that considers the point at which the Fisher's ratio value is maximum to be optimal.

The reference model learning unit 153 may accumulate and store data obtained by separating the foreground and background for the acquired spectral image 133 by the foreground separator 152. When the foreground and background separation data of the acquired spectral image 133 are accumulated more than a predefined amount, the reference model learning unit 153 may perform modeling of unsupervised learning by using the foreground and background separation data of the spectral image 133. For example, the reference model learning unit 153 may learn a classification model by using separated background spectrum clusters and multiple foreground spectrum clusters. In an example, in relation to type determination by the user, the reference model learning unit 153 may present (e.g., output through the display 160) a separated area of the spectral image corresponding to each separated cluster by N samples per class to the user. The class name may be set to any number or symbol. If there is the RGB image 135 stored together when taking the spectral image, the reference model learning unit 153 may output at least a portion of the RGB image 135 together when outputting a corresponding partial spectral image (or foreground spectral cluster). For example, the reference model learning unit 153 may output a partial RGB image of the area corresponding to the foreground area in the RGB image 135 to the display 160. Here, the timing of providing information for determining the type by the user may vary depending on a user input (or preference) among the states before model learning, during model learning, and after model learning. The user may check the presented separated area spectral image (e.g., foreground area spectral image) and enter, by using the input unit 140, information about what type the data corresponds to. Through this, the generated reference model may include at least one of a foreign matter model that contains foreign matters, and a general model that does not contain foreign matters. Alternatively, the reference model 131 may include foreign matter models corresponding to various foreign matters, respectively.

The foreign matter detector 154 may receive a current spectral image of the cathode active material 50 from the camera controller 151. In addition, when the spectral image acquired by the spectroscopic camera 120 is stored as a current spectral image in the memory 130, the foreign matter detector 154 may collect the spectral image 133 stored in the memory 130 to check whether the cathode active material 50 contains foreign matter. Additionally, the foreign matter detector 154 may transmit the spectral image 133 to the foreground separator 152 and separation data of the foreground and background from the foreground separator 152. The foreign matter detector 154 may perform unsupervised learning-based clustering using KNN or artificial neural network on at least one of the separated foreground spectrum and the spectrum including both the foreground and background of the current spectral image, and compare the clustering result with the reference model 131. In this process, the foreign matter detector 154 may perform segmentation on the spectral image 133 to detect the area containing the foreign matter. For example, the foreign matter detector 154 may separate the current spectral image 233 into a plurality of segment regions and compare each of the plurality of separated segment regions with the reference model 131 to check whether foreign matter is included. The foreign matter detector 154 may mark the segment region where the foreign matter is detected on the spectral image 133 (or the RGB image 135 corresponding to the spectral image 133) and output it to the display 160. Additionally, the foreign matter detector 154 may separate the segment region where foreign matter is detected, from segment regions where foreign matter is not detected. In this regard, the foreign matter detection device 100 may further include a partition device capable of partially isolating the cathode active materials 50 placed on the active material support 128, and a collection device capable of separating and collecting the cathode active material in the area where foreign matter is not detected and the cathode active material in the area where foreign matter is detected.

The foreign matter detection device 100 of the present disclosure described above separates the foreground and background of the spectral image obtained by the spectroscopic camera and compares it with the reference model. Therefore, the foreign matter detection device 100 can perform more accurate foreign matter detection, and perform more efficient detection of foreign matters by reducing the time and amount of calculations required to detect foreign matters.

FIG. 4 is a block diagram illustrating an exemplary configuration of a server device according to the first embodiment of the present disclosure. As described above, in the case where the foreign matter detection device 100 is designed to independently perform the foreign matter detection function, the configuration of the server device 200 may be omitted.

Referring to FIG. 4, the server device 200 may include a server communication circuit 210, a server memory 230, and a server processor 250.

The server communication circuit 210 may establish a communication channel with the foreign matter detection device 100. The server communication circuit 210 may receive at least one current spectral image from the foreign matter detection device 100 in response to a designated period or the occurrence of a predefined event. The server communication circuit 210 may receive a server reference model 231 from an external server device. The server communication circuit 210 may transmit an analysis result of at least one received current spectral image 233 to the foreign matter detection device 100 (or a designated user terminal) under the control of the server processor 250.

The server memory 230 may store at least one program or data necessary for operating the server device 200. In an example, the server memory 230 may store at least one of the current spectral image 233 collected and delivered by the foreign matter detection device 100, and the server reference model 231 for comparison with the current spectral image 233. The current spectral image 233 may be an image corresponding to the spectral image 133 stored in the memory 130 of the foreign matter detection device 100 described above. For example, the current spectral image 233 may include a currently acquired spectral image for the cathode active material 50. The server reference model 231 may correspond to the reference model 131 stored in the memory 130 of the foreign matter detection device 100 described above. In an example, the server reference model 231 may be generated by the foreign matter detection device 100 and provided to the server device 200. Alternatively, the server reference model 231 may be generated by the server processor 250, based on the current spectral image 233 stored in the server memory 230 over a predefined amount.

The server processor 250 may control transmitting and processing signals necessary for operating the server device 200, storing and transmitting results, or transmitting messages corresponding to the results. In this regard, the server processor 250 may include a data collector 251 and a foreign matter determinator 252.

The data collector 251 may establish a communication channel with the foreign matter detection device 100 and receive the current spectral image 233 of the cathode active material 50 from the foreign matter detection device 100. Here, the server device 200 may have the pre-stored server reference model 231, and if there is no server reference model 231, the data collector 251 may receive the server reference model 231 from an external server device. As mentioned above, the server reference model 231 may be created through model learning in the server device 200. In this regard, when the server device 200 is operated in a learning mode for the server reference model 231, the data collector 251 may collect various spectral images necessary for generating the server reference model 231 from an external server device or the foreign matter detection device 100. The data collector 251 may generate the server reference model 231 by separating foreground (e.g., the area where the cathode active material is distributed) and background (e.g., the area where the cathode active material is not distributed) for the collected spectral images, by learning a classification model using a separated background spectral cluster and multiple foreground spectral clusters, and by determining the type for the classification model (e.g. based on user confirmation and input).

The data collector 251 may receive the current spectral image 233 from the foreign matter detection device 100 in relation to a foreign matter detection request for the cathode active material 50. In this case, the data collector 251 may store the current spectral image 233 in the memory 130 along with identifier information of the foreign matter detection device 100, and request the foreign matter determinator 252 to analyze the current spectral image 233.

The foreign matter determinator 252 may perform analysis on the current spectral image 233 stored in the server memory 230. For example, the foreign matter determinator 252 may separate the foreground and background areas of the current spectral image 233, perform segmentation on the separated foreground spectrum, and compare each segment region with the server reference model 231 to detect foreign matter in the foreground spectrum of the cathode active material 50. In this operation, the foreign matter determinator 252 may distinguish the segment region where the foreign matter is detected, from other segment regions (e.g., the segment region where the foreign matter is not detected), and transmit this information to the foreign matter detection device 100.

As described above, the server device 200 according to the first embodiment of the present disclosure may separate the foreground spectra for the foreground area into a plurality of segment regions in the spectral image for the cathode active material 50, and compare each segment region with the server reference model 231 to identify the partial area where foreign matter is detected. As such, the server device 200 can reduce the amount of calculation by performing a foreign matter detection operation on the foreground area excluding the background area. Also, the server device 200 may divide the foreground area into a plurality of segment regions and identify the segment region where foreign matter is detected, thereby designating a local foreign matter detection area and separately collecting the cathode active material 50 in the area where no foreign matter is detected.

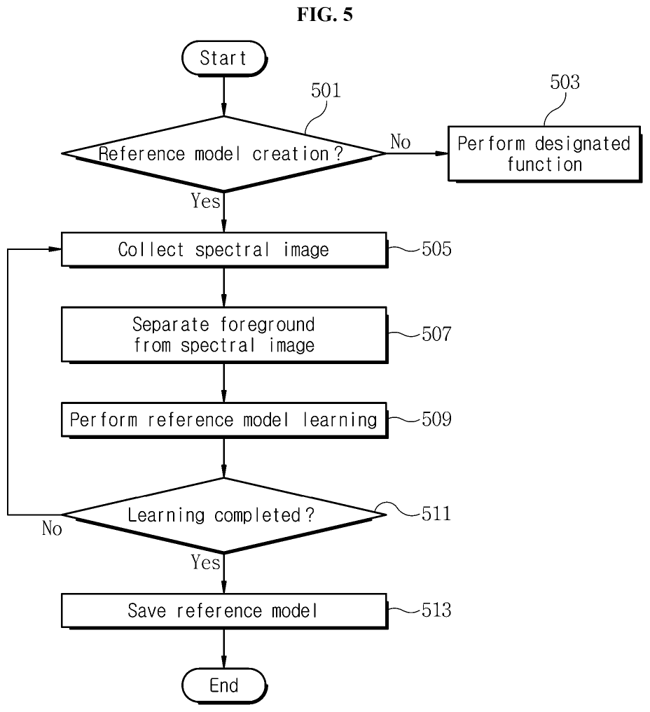

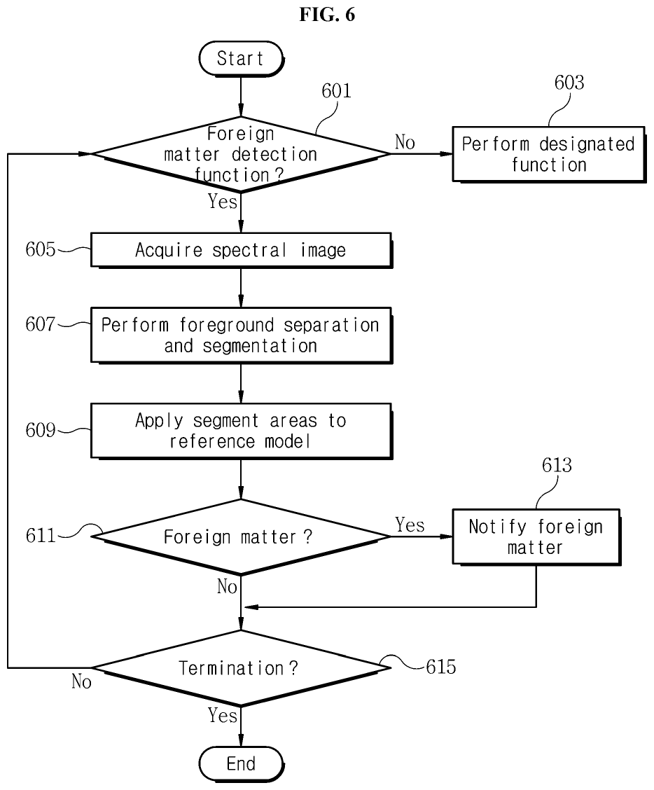

FIG. 5 is a flowchart illustrating an example of a method for detecting foreign matters in a cathode active material based on a spectral image according to the first embodiment of the present disclosure.

Referring to FIGS. 1 to 5, in the operation method of the foreign matter detection device 100, the processor 150 of the foreign matter detection device 100 may check in step 501 whether an event requesting the creation of a reference model occurs. The event requesting the creation of the reference model may include, for example, an event that the manager of the foreign matter detection device 100 inputs using the input unit 140, and an event that a request for generating and providing a reference model is received from the server device 200. Alternatively, the foreign matter detection device 100 may be designed to collect various spectral images related to the cathode active material 50 and generate the corresponding reference model 131 according to predefined scheduling information.

If no event related to the creation of the reference model 131 occurs, the processor 150 of the foreign matter detection device 100 may perform a designated function in step 503. For example, when the reference model has been already stored in the memory 130, or when the reference model is received from an external server device, the processor 150 of the foreign matter detection device 100 may provide a function of detecting foreign matters of the cathode active material, based on the reference model 131 stored in the memory 130.

When the event related to the creation of the reference model 131 occurs, the processor 150 of the foreign matter detection device 100 may collect spectral images related to the cathode active material 50 in step 505. In this operation, the processor 150 may perform access to an external server device that provides spectral images related to the cathode active material 50, and collect the spectral images from the external server device. Alternatively, by using the spectroscopic camera 120 connected to the foreign matter detection device 100, the processor 150 may photograph at least a partial area of the active material support 128 on which the cathode active material 50 is placed. The processor 150 may store and manage the photographed spectral image of the cathode active material 50 in the memory 130.

In step 507, the processor 150 may perform foreground separation of the acquired spectral image. In this regard, the processor 150 may perform unsupervised learning-based clustering on the wavelengths of the spectrum and calculate a cluster corresponding to the foreground spectrum by applying the KNN algorithm, artificial neural network (e.g., autoencoder), etc. In the case of collecting a plurality of spectral images for the cathode active material, the processor 160 may perform cluster creation through foreground separation and machine learning for each spectral image.

In step 509, the processor 150 may perform learning to create a reference model related to the cathode active material 50. In this operation, the processor 150 may calculate a certain pattern by comparing clusters calculated from the foreground spectra. The processor 150 may provide spectral images corresponding to cluster groups having certain patterns and also provide RGB images (e.g., RGB images acquired together at the time the spectral images are acquired) corresponding to the spectral images through the display 160 to perform a user validation process. The user can support the creation of the reference model for each type of foreign matter by checking at least one of the spectral image and the RGB image and inputting what type the cluster corresponding to the foreground spectrum corresponds to (e.g., whether it corresponds to a cathode active material containing foreign matter or a cathode active material without foreign matter). Here, the user can also input information for each type of foreign matter by checking the spectral image and the RGB image.

Next, in step 511, the processor 150 may check whether learning is completed. For example, the processor 150 may determine whether learning is completed by checking whether learning has been performed more than a predefined number of times or whether learning of various spectral images related to a cathode active material has been performed more than a predefined type. If learning is not completed, the processor 150 may return to step 505 and perform reference modeling learning on the foreground matrix area after separating the foreground for a predefined number of spectral images or a certain type or more. Meanwhile, the processor 150 may additionally perform reference model learning on a spectral image including both the foreground and background, in addition to modeling the foreground matrix area. Accordingly, the generated reference model may include, for example, at least one of a reference model created based on the foreground area and a reference model based on a spectral image including both the foreground and background.

When learning is completed, in step 513 the processor 150 may store the reference model 131 in the memory 130 or update the previously stored reference model. Alternatively, the processor 150 may provide the reference model 131 to the server device 200 that has requested the creation of the reference model 131.

FIG. 6 is a flowchart illustrating another example of a method for detecting foreign matters in a cathode active material based on a spectral image according to the first embodiment of the present disclosure.

Referring to FIGS. 1 to 6, in relation to the foreign matter detection function of the cathode active material 50, the processor 150 of the foreign matter detection device 100 may check in step 601 whether the execution of a foreign matter detection function of the cathode active material 50 is requested. If there is no request for spectral image collection, the processor 150 may perform a designated function in step 603. For example, the processor 150 may output the result of a previously performed foreign matter detection to the display 160 or update the reference model 131 in response to a user request. If there is no designated function, step 603 may be omitted.

When the execution of a foreign matter detection function is requested, the processor 150 of the foreign matter detection device 100 may acquire a spectral image of the cathode active material 50 in step 605. In this regard, the processor 150 of the foreign matter detection device 100 may activate a spectral image-based foreign matter detection application in response to a user input, and activate the spectroscopic camera 120 after activating the application. In addition, the processor 150 may adjust the vibration frequency and vibration area of the active material support 128 so that the cathode active material 50 is uniformly distributed on the active material support 128. When the cathode active material 50 is uniformly distributed, the processor 150 may control the spectroscopic camera 120 to obtain a spectral image of the cathode active material 50 placed on the active material support 128. Additionally, the processor 150 may adjust the distance and angle between the spectroscopic camera 120 and the cathode active material 50 so that the cathode active material 50 can be photographed at a predefined size. In order to adjust the distance and angle, the processor 150 may obtain a preview image by controlling the spectral camera 120 and, through analysis of the obtained preview image, adjust at least one of the distance and angle between the spectroscopic camera 120 and the cathode active material 50 so that the background area of a certain size is changed to a predefined size.

After acquiring the spectral image, the processor 150 may perform foreground separation and segmentation on the acquired spectral image in step 607. For the foreground separation, the processor 150 may utilize KNN (k-nearest neighbor) for the acquired spectral image, or may perform unsupervised learning-based clustering through an autoencoder which is an example of an artificial neural network. When using the KNN, the number of clusters may be determined by the user or by an automatic assignment method that considers the point at which the Fisher's ratio value is maximum to be optimal. After the foreground separation, the processor 150 may perform segmentation on the foreground spectrum. The number of segment regions may be predefined or may vary depending on the size of the captured spectral image.

The processor 150 may compare each segment region with the reference model 131 (or apply each segment region to the reference model) in step 609, and may detect in step 611 whether foreign matter is included.

If foreign matter is detected in step 611, the processor 150 may notify the presence of foreign matter in step 613. In this regard, the processor 150 may distinguish the segment region containing the foreign matter from other regions and output this information on the display 160 or transmit it to a designated device (e.g., user terminal).

Meanwhile, if no foreign matter is detected in step 611, the processor 150 may check in step 615 whether to terminate the foreign matter detection function. If no event related to termination of the foreign matter detection function occurs, the processor 150 may return to step 601 and re-perform the subsequent operations. If an event related to termination of the foreign matter detection function (such as a user input signal for terminating an application or an input signal instructing the stop of the spectroscopic camera 120) occurs, the processor 150 may terminate the foreign matter detection function.

Although it is exemplified in the above description that the foreign matter detection device 100 performs operations of acquiring a spectral image of the cathode active material 50 and determining whether foreign matter is detected in the cathode active material 50, the present disclosure is not limited thereto. Alternatively, the operations described above in FIG. 6 may be performed in the server device 200. In this case, the server device 200 may establish a communication channel with the foreign matter detection device 100 before step 601 and check in step 601 whether a spectral image is received. When the spectral image is received, the server device 200 may perform the subsequent operations from step 605 for the received spectral image.

As described above, in the first embodiment of the present disclosure, the function of detecting foreign matters in the cathode active material based on the spectral image determines whether or not foreign matters are included in each partial area of the spectral image through segmentation, so that efficient classification operation for the cathode active material can be performed.

### Second Embodiment

Hereinafter, a manufacturing system environment capable of managing the amount of a residue (e.g., residual lithium ions) during the manufacturing process of the cathode active material will be described. In addition, the types and roles of components included in the system will also be described.

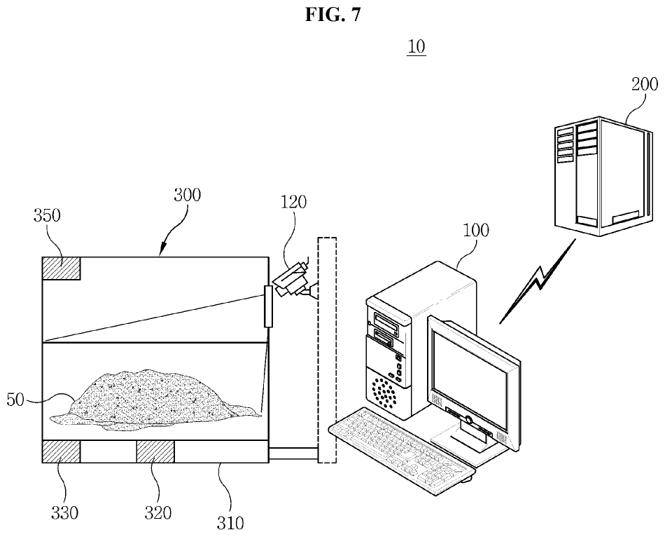

FIG. 7 is a diagram illustrating an example of a system environment supporting a residue management in a process of manufacturing a cathode active material according to a second embodiment of the present disclosure.

Referring to FIG. 7, the system environment 10 that supports management of the amount of residue to be removed (e.g., the amount of residual lithium ions) is in a state in which a cathode active material 50 containing residue in a manufacturing process is placed in a chamber 300. The system environment 10 may include the chamber 300 in which the cathode active material 50 is disposed, a residue control device 100 that detects residues (e.g., residual lithium ions) of the cathode active material 50 disposed in the chamber 300 and controls environment in the chamber 300, and a server device 200 connected to the residue control device 100. Although it is exemplified in the system environment 10 that the server device 200 establishes a communication channel with the residue control device 100 and supports the residue control device 100, the present disclosure is not limited thereto. For example, the system environment 10 may be configured to detect residues of the cathode active material 50 and control the chamber 300, based on an electronic device (e.g., the residue control device 100) capable of executing an embedded program without distinguishing the residue control device 100 and the server device 200. In this case, the server device 200 may be omitted from the system environment 10.

According to an embodiment, a method for manufacturing the cathode active material may include steps of preparing precursor for production of the cathode active material 50 by heat treatment, adding lithium hydroxide (LiOH—H₂O) and potassium ion salt to the prepared precursor to reduce residual lithium ions, creating a mixture by mixing lithium hydroxide (LiOH—H₂O) and potassium ion salt with the precursor, and then heating, holding and cooling the created mixture. A process of preparing the precursor may include steps of preparing an aqueous metal solution with at least one of nickel, cobalt, and manganese, mixing sodium carbonate as a precipitant and aqueous ammonia as a coprecipitant in the aqueous metal solution, stirring the mixture in a continuous reactor to obtain a precipitate, and then filtering, washing, and drying the obtained precipitate. The prepared precursor may have the composition formula of NiₓCo_{y}Mn_{z}(OH)₂. The precursor corresponds to a high nickel type precursor where x>0.5, y is approximately 0.2 to 0.4, and z is approximately 0.05 to 0.15. In an example, the structure of the precursor may have a core-shell structure or a single structure.

The potassium ion salt used in the mixture addition process during the above manufacturing process may be any salt containing potassium ion (K⁺). Specifically, KCl, KOH, KOH—H₂O, KI, KIO₃, KF, K₂CO₃, KNO₃, K₂S, K₂SO₄, K₂CrO₇, KMnO₄, KBr, KCN, KH₂PO₄, K₂CrO₄, CH₃COOK, C₆H₇KO₂, etc. are available. The lithium hydroxide (LiOH—H₂O) and the potassium ion salt may be added in an amount of about 0.9 to 1.4 mol per 1 mol of precursor.

In the heating process for the mixture, an elevated heating temperature environment is heating to 400 to 1000° C. at a rate of about 5 to 20ºC per minute, and after heating, the heating may be maintained at 400 to 1000° C. for about 9 to 11 hours. The cooling process may be a natural cooling process. The heat treatment process may be carried out under an oxygen atmosphere for a total of about 24 hours. Meanwhile, a process of mixing potassium ion salt with the cathode active material 50 and then heat-treating it to remove residual lithium ions may be further performed. In the process of managing the amount of residual lithium ions, the residue control device 100 may acquire a spectral image of materials in the chamber 300, determine the amount of residual lithium ions in the cathode active material 50 through analysis of the obtained spectral image, and if the residual lithium ion amount shows a pattern of less than a predefined reference value, perform the next process or finish a residual lithium ion removal process for the cathode active material 50. Through the above-described operation, the time of the cathode active material manufacturing process can be optimized, and the purity of the cathode active material 50 obtained through process completion can be maintained above a reference value, making it possible to manufacture a highly reliable cathode material. In the following description, the process of heat treatment by adding potassium ion salt to control the amount of residual lithium ions in the cathode active material 50 will be described as an example. However, the present disclosure is not limited thereto and can equally be applied to the process of creating a mixture in which lithium hydroxide and potassium ion salt are mixed with a precursor.

The cathode active material 50 is a major material constituting a cathode material and may be in powder form during a manufacturing process. For example, the cathode active material 50 may be manufactured as follows. Metal solutions are prepared by dissolving Ni, Co, and Mn in a strong acid solution such as sulfuric acid, and the prepared metal solutions are mixed to prepare a mixed metal solution. Then, a complexing agent is mixed to the mixed metal solution, and a pH adjuster such as NaOH is added to form and precipitate hydroxide. The precipitated hydroxide is washed and dried to prepare a precursor, and the precursor is produced into a metal oxide through a high temperature reaction. The metal oxide is mixed with a lithium-based material such as LiOH and fired in an oxidizing atmosphere to produce cathode active material powder. Thereafter, in order to control residual lithium ions, a heat treatment process may be performed after potassium ion salt is added to the cathode electrode active material 50. During this process, the cathode active material 50 may be located within the chamber 300.

The chamber 300 is a space where a heat treatment process to remove residual lithium ions is performed during the manufacturing process of the cathode active material 50. The chamber 300 may include a chamber housing 310 in which the cathode active material 50 containing the residual lithium ions can be placed, a temperature heating device 320 capable of increasing the temperature in the chamber housing 310, a temperature sensor 330 capable of measuring the temperature in the chamber housing 310, and a chamber controller 350 capable of controlling the temperature heating device 320 and the temperature sensor 330. Additionally, the chamber 300 may further include an opening and closing device capable of controlling the opening and closing of the chamber housing 310. In addition, the chamber 300 may further include a sensor that senses the arrangement state of the cathode active material 50 containing residual lithium ions. If it is set to detect the arrangement state of the cathode active material 50 using the spectroscopic camera 120, the sensor may be replaced with the spectroscopic camera 120.

The residue control device 100 may acquire a spectral image of the cathode active material 50 located in the chamber 300. In this regard, the residue control device 100 may include the spectroscopic camera 120, which may be arranged to photograph the cathode active material 50 disposed in the chamber 300. Alternatively, a window through which the spectroscopic camera 120 can take pictures may be formed on one side of the chamber housing 310 of the chamber 300.

The residue control device 100 may use a reference model in relation to controlling the amount of residual lithium ions in the cathode active material 50 disposed in the chamber 300. The reference model may be generated through unsupervised learning of the spectrum of a plurality of spectral images (or a predefined number of spectral images) in which the amount of residual lithium ions of the cathode active material 50 disposed in the chamber 300 is less than a predefined reference value (e.g., the residual lithium ion amount per unit volume is less than N %, where N is 10, 5, 3, etc. and may vary by an administrator). Additionally, the reference model 131 may include a model generated based on spectral images of the cathode active material 50 for each amount of residual lithium ions (e.g., clusters for each residual lithium ion amount generated through clustering of the spectra of the spectral images). In addition, the reference model 131 may include time series information. For example, heat treatment information (e.g., at least one of temperature rise rate, temperature rise value, and heating maintenance time) for changing the cathode active material 50 containing residual lithium ions above the reference value into a cathode active material containing residual lithium ions below the reference value may be included. The reference model may be received from an external server device that provides related information. Alternatively, the reference model may be generated by the residue control device 100.

The residue control device 100 may provide information on the cathode active materials 50 in which the residual lithium ion amount is detected to be greater than a predefined value. When the mixture of the cathode active material 50 and potassium ion salt is placed in the chamber 300, the residue control device 100 may provide control information (e.g., at least one of temperature rise rate, temperature rise value, and heating maintenance time) for adjusting the temperature environment of the chamber 300 to the chamber controller 350. The control information may vary depending on the amount of the cathode active material 50 and the amount of residual lithium ions contained in the cathode active material 50. The residue control device 100 may inspect the amount of residual lithium ions in the cathode active material 50 by taking spectral images of the cathode active material 50 in the chamber 300 in real time or at regular intervals. If it is determined that the amount of residual lithium ions in the cathode active material 50 is less than a predefined value, the residue control device 100 may provide relevant information to complete the process.

The residue control device 100 may manage the amount of residual lithium ions in the cathode active material 50 through the server device 200. In this case, the residue control device 100 may transmit the acquired spectral images of the cathode active material 50 in the chamber 300 to the server device 200 and receive information about the amount of residual lithium ions from the server device 200. Additionally, the residue control device 100 may be configured to independently perform the residual lithium ion amount management function without a separate server device 200.

The server device 200 may establish a communication channel with the residue control device 100. The server device 200 may receive at least one spectral image of the cathode active material 50 containing residual lithium ions from the residue control device 100, and detect the amount of residual lithium ions for the at least one received spectral image. In this process, the server device 200 may pre-store a reference model for comparative analysis of the currently acquired spectral image. The reference model may be created based on the spectrum of spectral images collected and provided by the residue control device 100. The server device 200 may provide the residual lithium ion amount result of the currently obtained spectral image for the cathode active material 50 to the residue control device 100. Additionally or alternatively, the server device 200 may create chamber control information according to the amount of residual lithium ions, and transmit the created chamber control information to the chamber 300 through the residue control device 100, or directly transmit it if a direct communication channel can be formed depending on the communication circuit configuration.

As described above, in the system environment 10 supporting the residual lithium ion management function of the cathode active material according to the second embodiment of the present disclosure, the residue control device 100 acquires a spectral image of the cathode active material 50 containing residual lithium ions, compares the spectral image spectrum (or its corresponding cluster) with a reference model, and performs heat treatment so that the amount of residual lithium ions is below a predefined value, thereby supporting the manufacture of highly reliable cathode active materials.

FIG. 8 is a block diagram illustrating an exemplary configuration of a residue management device according to the second embodiment of the present disclosure.

First, referring to FIG. 8, the residue control device 100 may include a communication circuit 110, a spectroscopic camera 120, a memory 130, an input unit 140, a display 160, and a processor 150. Additionally, as previously described in FIG. 7, the residue control device 100 may place the spectroscopic camera 120 on one side of the chamber 300 (e.g., a window through which the interior of the chamber 300 can be photographed) so that a spectral image of the cathode active material 50 containing residual lithium ions can be taken using the spectroscopic camera 120. When it is necessary to consider that flow of the chamber 300 may occur due to movement of the chamber housing 310, the residue control device 100 may further include a mounting structure capable of moving the spectroscopic camera 120 in at least one of the forward and backward, left and right, and up and down directions. In addition, the residue control device 100 may further include a power source (e.g., permanent power source or battery) required for the operation of at least one of the above-mentioned components such as the communication circuit 110, the spectroscopic camera 120, the memory 130, the input unit 140, the display 160, and the processor 150.

The communication circuit 110 may support the communication function of the residue control device 100. In an example, the communication circuit 110 may include a first communication circuit 111 capable of establishing a communication channel with the server device 200, and a second communication circuit 112 capable of establishing a communication channel with the chamber 300. In an embodiment, when the server device 200 is designed to perform calculations required for analyzing spectral images of the cathode active material 50 containing residual lithium ions, the first communication circuit 111 may transmit at least one spectral image collected by the spectroscopic camera 120 to the server device 200. In addition, under settings or the control of the processor 150, the first communication circuit 111 may receive the analysis result of the spectral image from the server device 200 and transmit it to the processor 150. In this regard, the first communication circuit 111 may communicate with the server device 200 based on either a short-range communication channel or a long-distance communication channel. The second communication circuit 112 may establish a wired communication channel or a short-range wireless communication channel with the chamber 300. In this regard, the chamber 300 may include a communication interface (e.g., a wired or wireless communication interface) capable of forming a communication channel with the residue control device 100. The second communication circuit 112 may transmit control information for controlling the temperature environment of the chamber 300 to the chamber 300 under the control of the processor 150. Also, the second communication circuit 112 may receive sensor information (e.g., temperature information within the chamber housing 310) from the chamber 300 and deliver it to the processor 150.

Additionally or alternatively, the communication circuit 110 (e.g., at least one of the first communication circuit 111 or the second communication circuit 112) may establish a communication channel with an external server device and receive the reference model 131 from the external server device. The reference model 131 may include a model generated based on machine learning (or self-supervised learning, or unsupervised learning) on spectral images of the cathode active material 50 containing residual lithium ions below at least a specified reference value. In this regard, the communication circuit 110 may establish a communication channel with an external server device at regular intervals under the control of the processor 150, and when there is a newly updated reference model 131, may receive the updated reference model 131 from the external server and store (or update) it in the memory 130. The communication circuit 110 may transmit at least one of information about the temperature environment of the chamber 300 and the amount of residual lithium ions of the cathode active material 50 to a designated user terminal (e.g., an administrator terminal that manages the chamber 300 or an administrator terminal of the residue control device 100).

The spectroscopic camera 120 is the spectroscopic camera 120 of the residue control device 100 previously described in FIG. 7 and may be arranged to capture a spectral image of the cathode active material 50 containing residual lithium ions. Although FIG. 7 shows that the residue control device 100 includes one spectroscopic camera 120, the present disclosure is not limited thereto. For example, a plurality of spectral cameras 120 may be disposed. In this case, the plurality of spectroscopic cameras may be arranged to photograph the cathode active material 50 from various angles. The spectroscopic camera 120 may be activated under the control of the processor 150, and when a spectral image of the cathode active material 50 is acquired, it can be transmitted to the processor 150. Alternatively, under the control of the processor 150, the spectral image acquired by the spectroscopic camera 120 may be transmitted to the server device 200 through the communication circuit 110 (e.g., the first communication circuit 111).

The memory 130 may store at least one program or data necessary for operating the residue control device 100. In an example, the memory 130 may temporarily or semi-permanently store a control program necessary for driving at least one spectroscopic camera 120, and a spectral image 133 acquired through the at least one spectroscopic camera 120. For example, the memory 130 may store the reference model 131 used for comparative analysis with a currently captured spectral image of the cathode active material 50. As mentioned above, the reference model 131 may be received from an external server device. If a plurality of spectral images 133 are accumulated and stored more than a predefined certain amount, the reference model 131 may be generated through the calculation of the processor 150 and a user input. The memory 130 may store chamber information 137. The chamber information 137 may include heat treatment information (e.g., at least one of temperature rise rate, temperature rise value, and heating maintenance time) for reducing the amount of residual lithium ions contained in the cathode active material 50 to below a reference value within a predefined time

The input unit 140 may include various input tools for manipulating the residue control device 100. For example, the input unit 140 may create, in response to a user's manipulation, at least one of an input signal for activating the spectroscopic camera 120, an input signal for manipulating the spectroscopic camera 120 to acquire the spectral image 133, and an input signal for requesting the analysis result of the spectral image 133. The input unit 140 may include at least one of a soft key (or a touch-sensitive input mechanism in a touch screen or a touch pad), a physical key, a voice input device, a gesture input device, a jog shuttle, and the like. Additionally or alternatively, the input unit 140 may receive a user input for controlling the temperature environment of the chamber 300. The user can control the temperature environment of the chamber 300 through the input unit 140.

The display 160 may output at least one screen necessary for operating the residue control device 100. For example, the display 160 may output at least one of the following screens: a screen that indicates whether at least one component (e.g., the spectroscopic camera 120, the communication circuit 110, the input unit 140) included in the residue control device 100 is in a normal state, a screen for activating the spectroscopic camera 120, a screen for showing the spectral image 133 acquired through the spectroscopic camera 120, a screen for showing the amount of residual lithium ions according to the analysis of the spectral image 133, and a screen showing information about the temperature environment of the chamber 300. In addition, when the residue control device 100 is operated in conjunction with the server device 200, the display 160 may output at least one of a screen for connecting with the server device 200, the amount of residual lithium ions of the spectral image 133 received from the server device 200, and control information of the chamber 300.

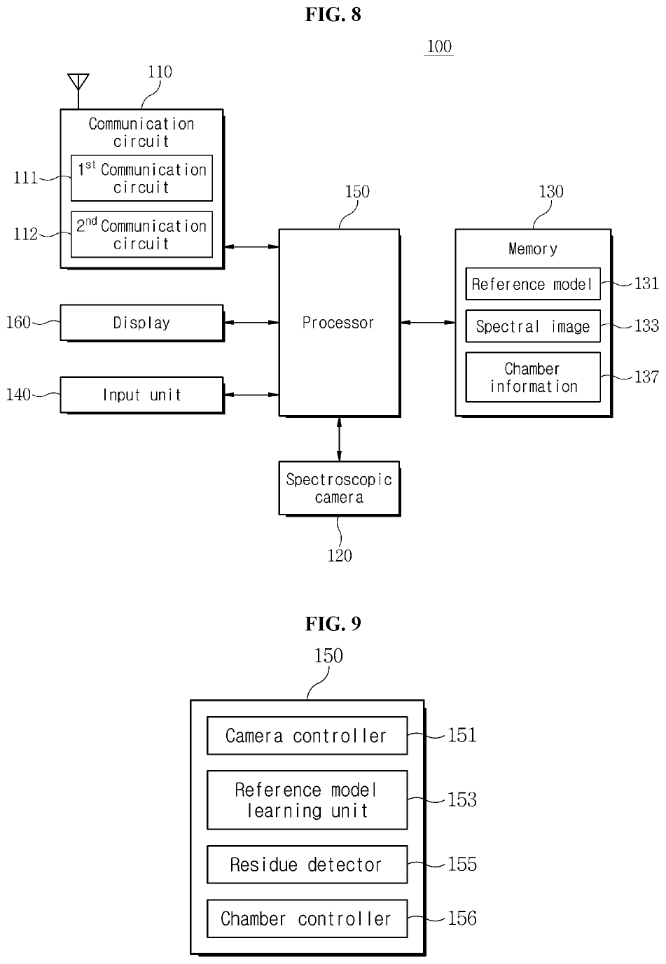

The processor 150 may perform at least one of transmitting and processing signals necessary for operating the residue control device 100, storing processing results, and outputting the processing results. For example, the processor 150 may perform a process of generating the reference model 131 based on at least one of a spectral image collected by the spectroscopic camera 120 or a spectral image received from an external server device. In addition, the processor 150 may acquire the spectral image 133 by controlling the spectroscopic camera 120, perform comparative analysis between the acquired spectral image 133 and the reference model 131 stored in the memory 130, output the residual lithium ion detection results according to the comparative analysis, and control the chamber 300 based on such results. In this regard, the processor 150 may include a configuration as shown in FIG. 9.

FIG. 9 is a block diagram illustrating an exemplary configuration of the processor shown in FIG. 8.

Referring to FIG. 9, the processor 150 may include at least one of a camera controller 151, a reference model learning unit 153, a residue detector 155, and a chamber controller 156.

The camera controller 151 may control the spectroscopic camera 120 so that the spectroscopic camera 120 can capture the cathode active material 50 containing residual lithium ions at a certain resolution or higher. In this regard, if necessary, the camera controller 151 may control a camera holder for the spectroscopic camera 120 to cause linear movement and rotational movement at a specific angle in at least one of forward and backward, left and right, and up and down directions, thereby adjusting the current position of the spectroscopic camera 120. The camera controller 151 may collect spectral images in real time or at regular intervals from the time the cathode active material 50 containing residual lithium ions is placed in the chamber 300, and may transmit the collected spectral images to the processor 150. Alternatively, the camera controller 151 may collect spectral images in real time or at regular intervals from the time the cathode active material 50 containing residual lithium ions is placed in the chamber 300 to the time the residue detector 155 requests it.

The reference model learning unit 153 may perform learning to generate a reference model through machine learning on the acquired spectral image 133. In this operation, the reference model learning unit 153 may separate the foreground (e.g., the area where the cathode active material 50 is placed) and the background (e.g., the area where the cathode active material 50 is not placed) in the collected spectral image. Subsequently, the reference model learning unit 153 may perform at least partial reference model learning (e.g., generating a reference model for a foreground portion or generating a reference model using a plurality of foreground portions and background portions). Alternatively, the separation operation of the foreground and background may be requested to the residue detector 155. The reference model learning unit 153 may perform clustering on the spectrum of the collected spectral images and generate the reference model 131 through unsupervised learning for each cluster. Alternatively, the reference model learning unit 153 may determine the type of residual lithium ion amount for each spectral image and generate the reference model 131 based on this. In this regard, the residue control device 100 may further include a detection device capable of detecting the amount of residual lithium ions in the cathode active material 50 disposed in the chamber 300. The detection device may be used temporarily to generate the reference model. The reference model learning unit 153 may perform cluster classification of spectral images based on the amount of residual lithium ions obtained from the detection device, and generate the reference model that classifies classes according to the amount of residual lithium ions. Alternatively, based on spectral images of the cathode active material 50 having a residual lithium ion amount less than a predefined reference value, the reference model learning unit 153 may classify the obtained spectral images into two groups (e.g., a spectral image group having the cathode active material 50 with a residual lithium ion amount greater than the reference value, and a spectral image group having the cathode active material 50 with a residual lithium ion amount less than the reference value), and generate the reference model 131 by using the group of spectral images. Meanwhile, the reference model learning unit 153 is a component added in the case where the residue control device 100 performs reference model generation. Thus, in the case where the reference model is received from an external server device, the reference model learning unit 153 may be omitted.

In an example, the reference model learning unit 153 collects data on the remaining amount (or residual amount) of a removal target, such as residual lithium ions, during the cathode active material manufacturing process. At this time, collection of residual amount data may be performed on a regular time basis. In collecting the residual amount data, the reference model learning unit 153 may further collect and match the temperature rise rate, heating temperature, cooling rate, etc. The reference model learning unit 153 may also collect information about which stage of the process the collected data belongs to and whether the process is in progress or finished (manufacturing completed). The reference model learning unit 153 may request the collection of spectral images for the cathode active material 50 during the above-described information collection process. That is, the reference model learning unit 153 may request the residue detector 155 to analyze the spectral images regarding the remaining amount of the removal target. Alternatively, the reference model learning unit 153 may request a detection device (or a separate measuring device) capable of detecting the removal target to provide information on the remaining amount of the removal target. Upon receiving the requested information, the reference model learning unit 153 may perform learning to create the reference model based on the received data. For example, in the learning process, input data may be a spectral image of the cathode active material 50 up to the current time point, the current temperature of the chamber 300, and the like. When the current time point is 0, data from time point, −t, may be entered. Here, the length of time step t may be specified selectively (e.g., based on a user input) or randomly. Meanwhile, the reference model 131 is an artificial neural network that can process time series data, and its structure is not limited. As an example, the model type may include a type that performs the task of predicting the next frame in a video input.

The residue detector 155 may receive a current spectral image (or target data, i.e., ground truth) of the cathode active material 50 containing residual lithium ions placed in the chamber 300 from the camera controller 151. In addition, when the spectral image acquired by the spectroscopic camera 120 is stored as a current spectral image in the memory 130, the residue detector 155 may collect the spectral image 133 stored in the memory 130 to determines whether the cathode active material 50 contains residual lithium ions greater than a reference value. In this operation, as required, according to settings, or according to a user input, the residue detector 155 may separate a foreground area (e.g., an area where the cathode active material 50 is disposed) and a background area (e.g., an area other than the foreground area) of the currently acquired spectral image 133 (or the spectral image for generating the reference model 131). The residue detector 155 may perform unsupervised learning-based clustering using KNN or artificial neural network on at least one of the separated foreground spectrum and the spectrum including both the foreground and background of the current spectral image, and compare the clustering result with the reference model 131. Alternatively, the residue detector 155 may compare the machine learning results for the acquired current spectral image 233 and the reference model 131 without foreground and background separation. In this process, the residue detector 155 may detect the cluster most similar to the cluster corresponding to the current spectral image 233 in the reference model 131, identify the amount of residual lithium ions based on information matched to the cluster, and check whether it is below a predefined reference value. Alternatively, the residue detector 155 may check whether the similarity between the cluster corresponding to the current spectral image 233 and the cluster model below a predefined reference value is within a predefined range. The residue detector 155 may transmit residual lithium ion amount information to the chamber controller 156.

In an example, the residue detector 155 may input data acquired in real time from the cathode active material manufacturing process to the model learned by the reference model learning unit 153 and infer the next state. Here, the next state may be one piece of data corresponding to the next time step (process), one piece of data after time point t, or N multiple data between time points t and t+N. The residue detector 155 (or the user of the residue control device 100 or the manager of the chamber 300) may utilize the inferred next state(s) as supplementary materials in decision making such as adjusting the temperature rise rate, heating temperature, cooling speed, etc., or preparing for the next task by predicting the end of the task. The residue detector 155 may determine whether to remove the residual lithium ions, based on the amount of the residual lithium ions according to the inferred next state.

When the chamber controller 156 receives residual lithium ion amount information from the residue detector 155, it may control the operation of the chamber 300 and the operation of the camera controller 151 according to the residual lithium ion amount. For example, when the amount of residual lithium ions in the cathode active material 50 is greater than a predetermined reference value (or when the similarity between the cluster corresponding to the current spectral image and a specific cluster of the reference model 131 (e.g., a model created based on a spectral image with a residual lithium ion amount less than the reference value) differs by more than a certain range), the chamber controller 156 may create control information to maintain the heating state of the chamber 300, transmit it to the chamber 300, and after a designated time has elapsed, request the camera controller 151 to acquire a spectral image. In addition, when the amount of residual lithium ions in the cathode active material 50 is less than the predetermined reference value (or when the similarity between the cluster corresponding to the current spectral image and a specific cluster of the reference model 131 (e.g., a model created based on a spectral image with a residual lithium ion amount less than the reference value) is within a certain range), the chamber controller 156 may terminate the heating state of the chamber 300, create control information to perform a subsequent operation (e.g., cooling operation), and transmit it to the chamber 300. At this time, the chamber controller 156 may request the camera controller 151 to terminate spectral image collection. The camera controller 151 may deactivate the spectroscopic camera 120 upon receiving the request.

As described above, in this embodiment, by determining in real time or periodically whether targets to be removed in the cathode active material manufacturing process, such as lithium ions, have been removed, the heat treatment process can be completed early and the next process can continue immediately. Therefore, the total process time can be optimized and product production volume can be maximized. Meanwhile, in the above description, removal of residual lithium ions from the cathode active material 50 has been described as an example, but the present disclosure is not limited thereto. The same method as the above-described lithium ion removal method can be applied to other materials that need to be removed from the cathode active material 50.

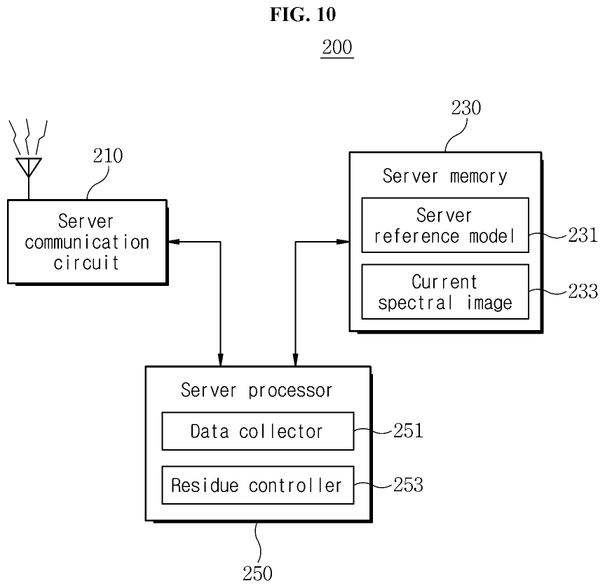

FIG. 10 is a block diagram illustrating an exemplary configuration of a server device according to the second embodiment of the present disclosure. As described above, in the case where the residue control device 100 is designed to independently perform the residual lithium ion management function, the configuration of the server device 200 may be omitted.

Referring to FIGS. 7 to 10, the server device 200 may include a server communication circuit 210, a server memory 230, and a server processor 250.

The server communication circuit 210 may establish a communication channel with the residue control device 100. The server communication circuit 210 may receive at least one current spectral image from the residue control device 100 in response to a designated period or the occurrence of a predefined event (e.g., an event that detects the state in which the cathode active material 50 containing residual lithium ions is placed in the chamber 300). The server communication circuit 210 may receive a server reference model 231 from an external server device. The server communication circuit 210 may transmit an analysis result of at least one received current spectral image 233 to the residue control device 100 (or a designated user terminal) under the control of the server processor 250. In addition, the server communication circuit 210 may create chamber control information according to the analysis result of the current spectral image 233 under the control of the server processor 250, and provide the created chamber control information to the residue control device 100. Alternatively, the server communication circuit 210 may establish a communication channel with the chamber 300 and directly transmit the chamber control information without going through the residue control device 100.

The server memory 230 may store at least one program or data necessary for operating the server device 200. In an example, the server memory 230 may store at least one of the current spectral image 233 collected and delivered by the residue control device 100, and the server reference model 231 for comparison with the current spectral image 233. The current spectral image 233 may be an image corresponding to the spectral image 133 stored in the memory 130 of the residue control device 100 described above. For example, the current spectral image 233 may include a currently acquired spectral image of the cathode active material 50 containing residual lithium ions. The server reference model 231 may correspond to the reference model 131 stored in the memory 130 of the residue control device 100 described above. In an example, the server reference model 231 may be generated by the residue control device 100 and provided to the server device 200. Alternatively, the server reference model 231 may be generated by the server processor 250, based on the current spectral image 233 stored in the server memory 230 over a predefined amount. Additionally or alternatively, the server memory 230 may further store chamber information related to chamber control. The chamber information may include temperature environment setting information of the chamber 300 for each amount of residual lithium ions contained in the cathode active material. The chamber information may include the same or similar information as the chamber information 137 previously described in FIG. 8.

The server processor 250 may control transmitting and processing signals necessary for operating the server device 200, storing and transmitting results, or transmitting messages corresponding to the results. In this regard, the server processor 250 may include a data collector 251 and a residue controller 253.

The data collector 251 may establish a communication channel with the residue control device 100 and receive the current spectral image 233 of the cathode active material 50 containing residual lithium ions from the residue control device 100. Here, the server device 200 may have the pre-stored server reference model 231, and if there is no server reference model 231, the data collector 251 may receive the server reference model 231 from an external server device. As mentioned above, the server reference model 231 may be created through model learning in the server device 200. In this regard, when the server device 200 is operated in a learning mode for the server reference model 231, the data collector 251 may collect a plurality of spectral images of the cathode active material 50 containing residual lithium ions required to generate the server reference model 231 from an external server device or the residue control device 100. The data collector 251 may generate the server reference model 231 by separating foreground (e.g., the area where the cathode active material 50 containing residual lithium ions is distributed) and background (e.g., the area other than the foreground area) for the collected spectral images, by learning a classification model using a separated background spectral cluster and multiple foreground spectral clusters, and by performing mapping with measurements of the amount of residual lithium ions contained in the cathode active material (e.g., measurements by a device for measuring the amount of residual lithium ions at the time of each spectral image acquisition). In this process, the data collector 251 may collect the cathode active material spectral image and current temperature value up to the current time point as input data for learning. For example, when the current time point is 0, the data collector 251 may use data from time point, −t, as input data for modeling for learning. Additionally, the data collector 251 may specify the length of time step, t, selectively, randomly, statistically, or in response to a user input according to a predefined rule. The server reference model 231 is an artificial neural network that can process time series data, and its structure is not limited. As an example of a model type, the server reference model 231 may be in a form that performs the task of predicting the next frame in a video input.

The data collector 251 may receive the current spectral image 233 from the residue control device 100 in connection with receiving a residue detection request for the cathode active material 50 containing residual lithium ions (e.g., a user input of the residue control device 100). In this case, the data collector 251 may store the current spectral image 233 in the memory 130 along with identifier information of the residue control device 100, and request the residue controller 253 to analyze the current spectral image 233. Additionally, when collecting the current spectral image 233 from the chamber 300, the data collector 251 may also collect information about the temperature environment and store it in the server memory 230.

The data collector 251 may collect residual amount data of a removal target such as lithium ions in the cathode active material manufacturing process. At this time, collection of residual amount data may be performed on a regular time basis. In collecting the residual amount data of the removal target, the data collector 251 may further collect at least one of the temperature rise rate, heating temperature, cooling rate, etc. of the chamber 300 and store it together with the current spectral image 233. In addition, the data collector 251 may also collect information about which stage of the cathode active material manufacturing process the collected data belongs to and whether the cathode active material manufacturing process is in progress or finished (manufacturing completed), etc., and store it together with the current spectral image 233.

The residue controller 253 may perform analysis on the current spectral image 233 stored in the server memory 230. For example, the residue controller 253 may separate the foreground and background areas of the current spectral image 233 and apply the separated foreground spectrum to the server reference model 231 to detect the amount of residual lithium ions. Alternatively, without foreground and background separation, based on the similarity between the clusters obtained through clustering of the spectrum of the spectral image 133 and the clusters included in the server reference model 231, the residue controller 253 may check whether the amount of residual lithium ions is below the reference value or what the amount of residual lithium ions is. In an example, the residue controller 253 may input the spectral images acquired in real time from the cathode active material manufacturing process to the learned model and infer the next state. Here, the next state may be one piece of data corresponding to the next time step, one piece of data after time point t, or N multiple data between time points t and t+N. The residue controller 253 may utilize the inferred next state(s) as supplementary materials in decision making such as adjusting the temperature rise rate, heating temperature, cooling speed, etc., or predicting the end of the task. The residue controller 253 may determine whether to remove the residual lithium ions, based on the amount of the residual lithium ions according to the inferred next state.

If the amount of residual lithium ions is greater than the reference value, the residue controller 253 may create control information for maintaining the heating state of the chamber 300, and transmit the control information to the chamber 300 directly or through the residue control device 100. If the amount of residual lithium ions is less than the reference value, the residue controller 253 may create control information for switching the heat treatment process of the chamber 300 to a cooling process, and transmit the control information to the chamber 300 directly or through the residue control device 100.

As described above, in order to manage the removal target (e.g., residual lithium ions) contained in the cathode active material 50, the server device 200 according to the second embodiment can identify the residual amount of the removal target during the manufacturing process of the cathode active material 50, and control the temperature environment. Accordingly, it is possible to adaptively adjust the residual amount, and it is supported to manufacture the cathode active material 50 in which the residual amount of the removal target is appropriately adjusted.

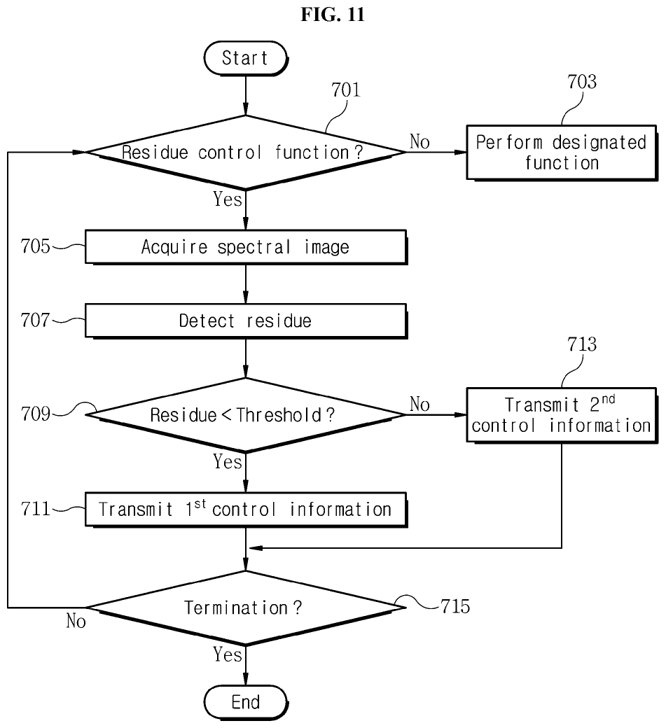

FIG. 11 is a flowchart illustrating an example of a method for managing residues in a cathode active material based on a spectral image according to the second embodiment of the present disclosure.

Referring to FIGS. 7 to 11, in the method for managing residues in a cathode active material according to the second embodiment, the processor 150 of the residue control device 100 may check in step 701 whether there is a request to execute a residue control function. An event requesting the execution of the residue control function may be an event that the manager of the residue control device 100 inputs a request to execute a corresponding application through the input unit 140, or an event that a request to execute the residue control function is received from the server device 200. In addition, the residue control device 100 may automatically execute the residue control function according to predefined scheduling. Also, the residue control device 100 may receive a notification about a state in which the cathode active material 50 containing residual lithium ions is located in the chamber housing 310, from the chamber 300 through a communication channel. In this case, the processor 150 of the residue control device 100 may determine the receipt of the notification as an event requesting the execution of the residue control function.

If no event requesting the execution of the residue control function is received in step 701, the processor 150 of the residue control device 100 may perform a designated function in step 703. For example, the processor 150 may output status values of at least some of the components of the residue control device 100. If there is no designated function, step 703 may be omitted.

If the execution of the residue control function (or residual lithium ion management function) is requested, the processor 150 of the residue control device 100 may acquire in step 705 a current spectral image for the cathode active material 50 containing residual lithium ions. In this regard, the processor 150 of the residue control device 100 may execute a residue control application for the cathode active material 50 in response to a user input, and activate the spectroscopic camera 120 to take the current spectral image according to the operation of the executed application.

After acquiring the current spectral image, the processor 150 may perform residue detection in step 707, based on the acquired spectral image. In this operation, the processor 150 may selectively perform foreground and background separation on the current acquired spectral image. For foreground separation, the processor 150 may utilize KNN (k-nearest neighbor) for the acquired spectral image, or may perform unsupervised learning-based clustering through an autoencoder which is an example of an artificial neural network. Alternatively, without foreground and background separation, the processor 150 may perform machine learning-based clustering on the spectral image and apply it to the pre-stored reference model 131 to identify the amount of residual lithium ions.

Next, in step 709, the processor 150 of the residue control device 100 may check whether the residual amount of the removal target (e.g., residual lithium ions) is less than a predefined reference value (i.e., threshold). If the residual amount of the removal target is less than the reference value, the processor 150 may create first control information necessary for controlling the chamber 300 and transmit the first control information to the chamber 300 in step 711. For example, in step 711, the processor 150 may create first control information to perform the next step (e.g., cooling process) of the current heat treatment process, and transmit it to the chamber 300. The first control information may include information about the cooling environment (e.g., at least one of cooling rate and cooling temperature).

If the residual amount of the removal target is greater than the reference value, the processor 150 may create second control information (e.g., information different from the first control information) necessary for controlling the chamber 300 and transmit the second control information to the chamber 300 in step 713. For example, in step 713, the processor 150 may create second control information set to maintain the current heat treatment process or set to increase the temperature value in the current heat treatment process, and transmit it to the chamber 300. The second control information may be information about the heating maintenance environment (e.g., at least one of the heating temperature value and the heating maintenance time) or information about the temperature rise environment (e.g., at least one of the temperature rise temperature, the temperature rise rate, and the heating maintenance time after the target temperature rise value).

In step 715, the processor 150 of the residue control device 100 may check whether to terminate the residue control function (or the residual lithium ion management function). If no event related to the termination of the residue control function occurs, the processor 150 may return to step 701 and re-perform the subsequent operations. If an event (e.g., a user input for the termination of an application or an input instructing the termination of the spectroscopic camera 120, etc.) related to the termination of the residue control function occurs, the processor 150 may determine this event as the termination of the residue control function and terminate the related function.

Although it is exemplified in the above description that the residue control device 100 performs controlling the amount of a residue (e.g., residual lithium ions) contained in the cathode active material 50, the present disclosure is not limited thereto. Alternatively, the operations described above in FIG. 11 may be performed in the server device 200. In this case, the server device 200 may establish a communication channel with the residue control device 100 before step 701 and receive a message requesting the execution of the residue control function from the residue control device 100 in step 701. Thereafter, when the spectral image is received in step 705, the server device 200 may perform operations of steps 707 to 715 for the received spectral image.

As described above, the residue control function (or removal target residue management function, or residual lithium ion management function) for the cathode active material according to the second embodiment of the present disclosure identifies the residual amount of the removal target based on the spectral image during the process, and adaptively control the chamber 300 according to the identified residual amount. Therefore, it supports the process to proceed more efficiently and obtain highly reliable results (e.g., the cathode active material 50).

While the specification contains many specific implementation details, these should not be construed as limitations on the scope of the present disclosure or of what may be claimed, but rather as descriptions of features that may be specific to particular embodiments of particular disclosure.

Also, although the present specifications describe that operations are performed in a predetermined order with reference to a drawing, it should not be construed that the operations are required to be performed sequentially or in the predetermined order, which is illustrated to obtain a preferable result, or that all of the illustrated operations are required to be performed. In some cases, multi-tasking and parallel processing may be advantageous. Also, it should not be construed that the division of various system components are required in all types of implementation. It should be understood that the described program components and systems are generally integrated as a single software product or packaged into a multiple-software product.

This description shows the best mode of the present invention and provides examples to illustrate the present invention and to enable a person skilled in the art to make and use the present invention. The present invention is not limited by the specific terms used herein. Based on the above-described embodiments, one of ordinary skill in the art can modify, alter, or change the embodiments without departing from the scope of the present invention.

Accordingly, the scope of the present invention should not be limited by the described embodiments and should be defined by the appended claims.

What is claimed is:

1. A spectral image-based foreign matter detection device comprising:
a spectroscopic camera that acquires a spectral image of a cathode active material; and
a processor functionally connected to the spectroscopic camera and configured to:
control the spectroscopic camera to acquire a current spectral image of the cathode active material,
separate a foreground area where the cathode active material is distributed, and a background area other than the foreground area in the current spectral image,
divide the separated foreground area into a predefined number of segment regions,
compare each of the segment regions with a pre-stored reference model to determine whether a foreign matter is contained, and
output information about the segment region containing the foreign matter.

2. The foreign matter detection device of claim 1, wherein the processor is configured to distinguish between a segment region containing the foreign matter and a segment region not containing the foreign matter, and to output distinguished information to a display.

3. The foreign matter detection device of claim 2, wherein the processor is configured to separately classify the cathode active material of the segment region containing the foreign matter and the cathode active material of the segment region not containing the foreign matter.

4. The foreign matter detection device of claim 1, wherein the processor is configured to separate the foreground area and the background area through unsupervised learning-based clustering by applying a nearest neighbor technique or an autoencoder to the current spectral image.

5. The foreign matter detection device of claim 1, wherein the processor controls a vibration of an active material support on which the cathode active material is placed, so that the cathode active material is distributed to a uniform thickness.

6. The foreign matter detection device of claim 1, wherein the processor is configured to transmit information about the segment region containing the foreign matter to a user terminal.

7. A spectral image-based foreign matter detection method, performed by a processor of a foreign matter detection device, the method comprising:
controlling a spectroscopic camera to acquire a current spectral image of a cathode active material;
separating a foreground area where the cathode active material is distributed, and a background area other than the foreground area in the current spectral image;
dividing the separated foreground area into a predefined number of segment regions;
comparing each of the segment regions with a pre-stored reference model to determine whether a foreign matter is contained; and
outputting information about the segment region containing the foreign matter.

8. The foreign matter detection method of claim 7, wherein the outputting includes at least one of:
distinguishing between a segment region containing the foreign matter and a segment region not containing the foreign matter, and outputting distinguished information to a display; and
transmitting information about the segment region containing the foreign matter to a user terminal.

9. The foreign matter detection method of claim 8, further comprising:
separately classifying the cathode active material of the segment region containing the foreign matter and the cathode active material of the segment region not containing the foreign matter.

10. The foreign matter detection method of claim 7, wherein the separating includes:
separating the foreground area and the background area through unsupervised learning-based clustering by applying a nearest neighbor technique or an autoencoder to the current spectral image.

11. A server device supporting a spectral image-based foreign matter detection, the server device comprising:
a server communication circuit establishing a communication channel with a foreign matter detection device; and
a server processor functionally connected to the server communication circuit and configured to:
acquire a current spectral image of a cathode active material from the foreign matter detection device,
separate a foreground area where the cathode active material is distributed, and a background area other than the foreground area in the current spectral image,
divide the separated foreground area into a predefined number of segment regions,
compare each of the segment regions with a pre-stored reference model to determine whether a foreign matter is contained, and
transmit information about the segment region containing the foreign matter to the foreign matter detection device.

12. The server device of claim 11, wherein the server processor is configured to distinguish between a segment region containing the foreign matter and a segment region not containing the foreign matter, and to transmit distinguished information to the foreign matter detection device.

13. A spectral image-based residue control device comprising:
a spectroscopic camera that acquires a spectral image of a cathode active material; and
a processor functionally connected to the spectroscopic camera and configured to:
acquire a current spectral image of the cathode active material disposed in a chamber and containing a removal target during a heat treatment process for removing the removal target from the cathode active material,
identify a residual amount of the removal target by comparing a spectrum corresponding to the current spectral image with a pre-stored reference model, and
control an operation of the chamber differently depending on the residual amount of the removal target.

14. The residue control device of claim 13, wherein the removal target includes residual lithium ions contained in the cathode active material.

15. The residue control device of claim 13, wherein the processor is configured to create first control information for performing a next process during the heat treatment process when the residual amount of the removal target is less than a predefined reference value, and to transmit the first control information to the chamber, and
wherein the first control information includes at least one of a cooling temperature and a cooling rate related to a cooling process of the chamber.

16. The residue control device of claim 13, wherein the processor is configured to create second control information for repeating the heat treatment process when the residual amount of the removal target is greater than or equal to a predefined reference value, and to transmit the second control information to the chamber, and
wherein the second control information includes at least one of:
at least one of a temperature value and a heating maintenance time related to maintaining a heating state in the chamber, and
at least one of a temperature rise rate, a temperature rise value, and a heating maintenance time in the chamber.

17. The residue control device of claim 13, wherein the processor is configured to output, on a display, information about at least one of a temperature rise rate, a heating temperature, a cooling rate, and a work termination in the chamber, which vary depending on the residual amount of the removal target.

18. A spectral image-based residue control method, performed by a processor of a residue control device, the method comprising:
acquiring a current spectral image of a cathode active material disposed in a chamber and containing a removal target during a heat treatment process for removing the removal target from the cathode active material;
identifying a residual amount of the removal target by comparing a spectrum corresponding to the current spectral image with a pre-stored reference model; and
controlling an operation of the chamber differently depending on the residual amount of the removal target.

19. The residue control method of claim 18, wherein the controlling includes:
creating first control information for performing a next process during the heat treatment process when the residual amount of the removal target is less than a predefined reference value, and
transmitting the first control information to the chamber.

20. The residue control method of claim 18, wherein the controlling includes:
creating second control information for repeating the heat treatment process when the residual amount of the removal target is greater than or equal to a predefined reference value, and
transmitting the second control information to the chamber.

21. A server device supporting a spectral image-based residue control, the server device comprising:
a server communication circuit establishing a communication channel with a residue control device; and
a server processor functionally connected to the server communication circuit and configured to:
receive, from the residue control device, a current spectral image of a cathode active material disposed in a chamber and containing a removal target during a heat treatment process for removing the removal target from the cathode active material,
identify a residual amount of the removal target by comparing a spectrum corresponding to the current spectral image with a pre-stored reference model, and
control an operation of the chamber differently depending on the residual amount of the removal target.

22. The server device of claim 21, wherein the server processor is configured to:
create first control information for performing a next process during the heat treatment process when the residual amount of the removal target is less than a predefined reference value, and transmit the first control information to the chamber, or
create second control information for repeating the heat treatment process when the residual amount of the removal target is greater than or equal to a predefined reference value, and transmit the second control information to the chamber.
